(19) United States
(12) Patent Application Publication
(10) Pub. No.: US 2024/0056993 A1
(43) Pub. Date: Feb. 15, 2024

(54) DYNAMIC PER-BEAM SYNCHRONIZATION SIGNAL PERIODICITY

(71) Applicant: QUALCOMM Incorporated, San Diego, CA (US)

(72) Inventors: Yehonatan Dallal, Kfar Saba (IL); Idan Michael Horn, Hod Hasharon (IL); Shay Landis, Hod Hasharon (IL); Amit Bar-Or Tillinger, Tel-Aviv (IL)

(21) Appl. No.: 17/884,664

(22) Filed: Aug. 10, 2022

(51) Int. Cl. H04W 56/00; H04W 74/08

(52) U.S. Cl. CPC H04W 56/0005; H04W 74/08

(57) ABSTRACT

Methods, systems, and devices for wireless communications are described. In some implementations, a wireless communications network may support per-beam synchronization signal block (SSB) periodicity configurations. A network entity may transmit, using a first beam, a first SSB associated with a cell supported by the network entity. The first SSB may include a first broadcast channel that indicates a first periodicity for transmission of the first SSB associated using the first beam. In addition, the network entity may transmit, using a second beam, a second SSB associated with the cell supported by the network entity. The second SSB may include a second broadcast channel that indicates a second periodicity for transmission of the second SSB associated with the cell using the second beam. In such cases, the second periodicity may be different from the first periodicity.

### FIELD OF TECHNOLOGY

The following relates to wireless communications, including dynamic per-beam synchronization signal periodicity.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support dynamic per-beam synchronization signal periodicity. For example, the described techniques support per-beam configuration of synchronization signal block (SSB) periodicity. Some wireless communications systems may experience variable network traffic based on, for example, different times of day or different events taking place in an area. To gain access to wireless service, a user equipment (UE) may synchronize with a network entity. The UE may monitor for synchronization signal blocks (SSBs) transmitted from a network entity with a set (e.g., fixed) periodicity on different beams, and the UE may use the SSBs to establish a beam pairing for subsequent communications with the network. In some implementations, a network entity may transmit SSBs over each beam with the same set periodicity, and UEs within different areas of the coverage area may receive the SSBs according to the set periodicity. In some cases, however, there may be areas (e.g., geographic coverage areas or regions) that may have a higher UE density relative to other areas, and may benefit from a reduced or shorter SSB periodicity (i.e., more SSBs per a given duration) enabling a greater number of UEs to perform initial access. Similarly, there may be areas in the network that have relatively low UE density, and may operate using an increased SSB periodicity (i.e., fewer SSBs per a given duration).

To support efficient communications for wireless networks having variable user density, a network may support a per-beam SSB periodicity that may be dynamically changed based on observed channel conditions. For example, a network entity may transmit a first beam which includes a first SSB in accordance with a first periodicity, and may transmit one or more secondary beams with second periodicities different from the first periodicity. In such cases, the network entity may configure different SSB periodicities for different beams in an SSB burst transmitted across a coverage area.

A method for wireless communication at a network entity is described. The method may include transmitting, using a first beam associated with the network entity, a first SSB associated with a cell supported by the network entity, the first SSB including a first broadcast channel that indicates a first periodicity for transmission of the first SSB associated with the cell using the first beam and transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity.

An apparatus for wireless communication at a network entity is described. The apparatus may include a processor, memory coupled with the processor, and instructions stored in the memory. The instructions may be executable by the processor to cause the apparatus to transmit, using a first beam associated with the network entity, a first SSB associated with a cell supported by the network entity, the first SSB including a first broadcast channel that indicates a first periodicity for transmission of the first SSB associated with the cell using the first beam and transmit, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity.

Another apparatus for wireless communication at a network entity is described. The apparatus may include means for transmitting, using a first beam associated with the network entity, a first SSB associated with a cell supported by the network entity, the first SSB including a first broadcast channel that indicates a first periodicity for transmission of the first SSB associated with the cell using the first beam and means for transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity.

A non-transitory computer-readable medium storing code for wireless communication at a network entity is described. The code may include instructions executable by a processor to transmit, using a first beam associated with the network entity, a first SSB associated with a cell supported by the network entity, the first SSB including a first broadcast channel that indicates a first periodicity for transmission of the first SSB associated with the cell using the first beam and transmit, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity.

Some examples of the method, apparatuses, and non-transitory computer-readable medium described herein may further include operations, features, means, or instructions for monitoring for a first quantity of channel contentions on a first uplink channel of the cell corresponding to the first beam and a second quantity of channel contentions on a second uplink channel of the cell corresponding to the second beam, the first quantity of channel contentions and the second quantity of channel contentions associated with one or more user equipment (UE) attempting to access the first uplink channel and the second uplink channel, adjusting the first periodicity for transmission of the first SSB based on the first quantity of channel contentions, adjusting the second periodicity for transmission of the second SSB based on the second quantity of channel contentions, and transmitting the first SSB and the second SSB in accordance with the first adjusted periodicity and the second adjusted periodicity.

Some examples of the method, apparatuses, and non-transitory computer-readable medium described herein may further include operations, features, means, or instructions for adjusting the first periodicity, the second periodicity, or both, based on the first quantity of channel contentions satisfying a threshold number of channel contentions for the first beam, the second quantity of channel contentions satisfying the threshold number of channel contentions for the second beam, or both and transmitting the first SSB and the second SSB in accordance with the first adjusted periodicity and the second adjusted periodicity.

In some examples of the method, apparatuses, and non-transitory computer-readable medium described herein, adjusting the first periodicity, the second periodicity, or both may include operations, features, means, or instructions for decreasing the first periodicity, the second periodicity, or both, based on the first quantity of channel contentions being greater than the threshold number of channel contentions for the first beam, the second quantity of channel contentions being greater than the threshold number of channel contentions for the second beam, or both and transmitting the first SSB and the second SSB in accordance with the first decreased periodicity and the second decreased periodicity.

In some examples of the method, apparatuses, and non-transitory computer-readable medium described herein, adjusting the first periodicity, the second periodicity, or both may include operations, features, means, or instructions for increasing the first periodicity, the second periodicity, or both, based on the first quantity of channel contentions being less than the threshold number of channel contentions for the first beam, the second quantity of channel contentions being less than the threshold number of channel contentions for the second beam, or both and transmitting the first SSB and the second SSB in accordance with the first increased periodicity and the second increased periodicity.

Some examples of the method, apparatuses, and non-transitory computer-readable medium described herein may further include operations, features, means, or instructions for obtaining user density distribution information associated with a spatial distribution of the one or more UE for one or more time periods, adjusting the first periodicity, the second periodicity, or both, in accordance with the user density distribution information, and transmitting the first SSB and the second SSB in accordance with the first adjusted periodicity and the second adjusted periodicity.

Some examples of the method, apparatuses, and non-transitory computer-readable medium described herein may further include operations, features, means, or instructions for obtaining the user density distribution information based on a set of statistical user trends observed by the network entity for at least the one or more time periods.

In some examples of the method, apparatuses, and non-transitory computer-readable medium described herein, the first quantity of channel contentions and the method, apparatuses, and non-transitory computer-readable medium may include further operations, features, means, or instructions for adjusting the first periodicity, the second periodicity, or both, during the second time period based on the change in the first quantity of channel contentions, the change in the second quantity of channel contentions, or both and transmitting the first SSB and the second SSB in accordance with the first adjusted periodicity and the second adjusted periodicity.

Some examples of the method, apparatuses, and non-transitory computer-readable medium described herein may further include operations, features, means, or instructions for transmitting, via the first broadcast channel, a first message including a first indication of the first periodicity for transmission of the first SSB using the first beam, and first position information of the first SSB in a corresponding synchronization signal burst and transmitting, via the second broadcast channel, a second message including a second indication of the second periodicity for transmission of the second SSB using the second beam, and second position information of the second SSB in the corresponding synchronization signal burst.

In some examples of the method, apparatuses, and non-transitory computer-readable medium described herein, the first position information includes a first bitmap indicating locations of the first SSB in the corresponding synchronization signal burst, and the second position information includes a second bitmap indicating locations of the second SSB in the corresponding synchronization signal burst.

In some examples of the method, apparatuses, and non-transitory computer-readable medium described herein, the first indication includes one or more fields in the first message corresponding to the first beam and the second indication includes one or more fields in the second message corresponding to the second beam.

Some examples of the method, apparatuses, and non-transitory computer-readable medium described herein may further include operations, features, means, or instructions for selecting the first periodicity and the second periodicity from a set of periodicities for transmission of the first SSB and the second SSB and transmitting the first message including the selected first periodicity and the second message including the selected second periodicity.

In some examples of the method, apparatuses, and non-transitory computer-readable medium described herein, the first broadcast channel includes a first master information block (MIB) that indicates the first periodicity for transmission of the first SSB associated with the first beam, and the second broadcast channel includes a second MIB that indicates the second periodicity for transmission of the second SSB associated with the second beam.

Some examples of the method, apparatuses, and non-transitory computer-readable medium described herein may further include operations, features, means, or instructions for transmitting, using a third beam associated with the network entity, a third SSB associated with the cell supported by the network entity, the third SSB including a third broadcast channel that indicates a third periodicity for transmission of the third SSB associated with the cell using the third beam, the third periodicity being different from the first periodicity and the second periodicity.

A method for wireless communication at a UE is described. The method may include receiving a first synchronization signal and a second synchronization signal including time and frequency synchronization information for communications on a cell supported by a network entity and receiving a first SSB associated with the cell, the first SSB including a first broadcast channel that indicates a first beam-specific periodicity associated with transmission of the first SSB via a first beam.

An apparatus for wireless communication at a UE is described. The apparatus may include a processor, memory coupled with the processor, and instructions stored in the memory. The instructions may be executable by the processor to cause the apparatus to receive a first synchronization signal and a second synchronization signal including time and frequency synchronization information for communications on a cell supported by a network entity and receive a first SSB associated with the cell, the first SSB including a first broadcast channel that indicates a first beam-specific periodicity associated with transmission of the first SSB via a first beam.

Another apparatus for wireless communication at a UE is described. The apparatus may include means for receiving a first synchronization signal and a second synchronization signal including time and frequency synchronization information for communications on a cell supported by a network entity and means for receiving a first SSB associated with the cell, the first SSB including a first broadcast channel that indicates a first beam-specific periodicity associated with transmission of the first SSB via a first beam.

A non-transitory computer-readable medium storing code for wireless communication at a UE is described. The code may include instructions executable by a processor to receive a first synchronization signal and a second synchronization signal including time and frequency synchronization information for communications on a cell supported by a network entity and receive a first SSB associated with the cell, the first SSB including a first broadcast channel that indicates a first beam-specific periodicity associated with transmission of the first SSB via a first beam.

Some examples of the method, apparatuses, and non-transitory computer-readable medium described herein may further include operations, features, means, or instructions for performing a first quantity of channel contentions on a first uplink channel of the cell corresponding to the first beam and receiving an adjusted first beam-specific periodicity for transmission of the first SSB based on the first quantity of channel contentions.

In some examples of the method, apparatuses, and non-transitory computer-readable medium described herein, the adjusted first beam-specific periodicity may be based on the first quantity of channel contentions satisfying a threshold number of channel contentions for the first beam.

Some examples of the method, apparatuses, and non-transitory computer-readable medium described herein may further include operations, features, means, or instructions for receiving a decreased first beam-specific periodicity based on the first quantity of channel contentions being greater than the threshold number of channel contentions for the first beam.

Some examples of the method, apparatuses, and non-transitory computer-readable medium described herein may further include operations, features, means, or instructions for receiving an increased first beam-specific periodicity based on the first quantity of channel contentions being less than the threshold number of channel contentions for the first beam.

In some examples of the method, apparatuses, and non-transitory computer-readable medium described herein, the adjusted first beam-specific periodicity may be based on user density distribution information associated with a spatial distribution of the UE and one or more UE for one or more time periods.

In some examples of the method, apparatuses, and non-transitory computer-readable medium described herein, the adjusted first beam-specific periodicity may be based on a change in the first quantity of channel contentions during a first time period.

Some examples of the method, apparatuses, and non-transitory computer-readable medium described herein may further include operations, features, means, or instructions for receiving, via the first broadcast channel, a first message including a first indication of the first beam-specific periodicity for transmission of the first SSB using the first beam, and first position information of the first SSB in a corresponding synchronization signal burst.

In some examples of the method, apparatuses, and non-transitory computer-readable medium described herein, the first position information includes a first bitmap indicating locations of the first SSB in the corresponding synchronization signal burst.

In some examples of the method, apparatuses, and non-transitory computer-readable medium described herein, the first indication includes one or more fields in the first message corresponding to the first beam.

Some examples of the method, apparatuses, and non-transitory computer-readable medium described herein may further include operations, features, means, or instructions for receiving the first message including the first beam-specific periodicity indicated from a set of periodicities for transmission of the first SSB.

In some examples of the method, apparatuses, and non-transitory computer-readable medium described herein, the first broadcast channel includes a first MIB that indicates the first beam-specific periodicity for transmission of the first SSB associated with the first beam.

Some examples of the method, apparatuses, and non-transitory computer-readable medium described herein may further include operations, features, means, or instructions for receiving, using a second beam associated with the network entity, a second SSB associated with the cell that corresponds to the UE, the second SSB including a second broadcast channel that indicates a second beam-specific periodicity for reception of the second SSB associated with the cell using the second beam, the second beam-specific periodicity being different from the first beam-specific periodicity.

### BRIEF DESCRIPTION OF THE DRAWINGS

FIG. 1-5 illustrate examples of wireless communications systems that support dynamic per-beam synchronization signal periodicity in accordance with one or more aspects of the present disclosure.

FIG. 6 illustrates an example of a process flow that supports dynamic per-beam synchronization signal periodicity in accordance with one or more aspects of the present disclosure.

FIGS. 7 and 8 show block diagrams of devices that support dynamic per-beam synchronization signal periodicity in accordance with one or more aspects of the present disclosure.

FIG. 9 shows a block diagram of a communications manager that supports dynamic per-beam synchronization signal periodicity in accordance with one or more aspects of the present disclosure.

FIG. 10 shows a diagram of a system including a device that supports dynamic per-beam synchronization signal periodicity in accordance with one or more aspects of the present disclosure.

FIGS. 11 and 12 show block diagrams of devices that support dynamic per-beam synchronization signal periodicity in accordance with one or more aspects of the present disclosure.

FIG. 13 shows a block diagram of a communications manager that supports dynamic per-beam synchronization signal periodicity in accordance with one or more aspects of the present disclosure.

FIG. 14 shows a diagram of a system including a device that supports dynamic per-beam synchronization signal periodicity in accordance with one or more aspects of the present disclosure.

FIGS. 15 through 19 show flowcharts illustrating methods that support dynamic per-beam synchronization signal periodicity in accordance with one or more aspects of the present disclosure.

### DETAILED DESCRIPTION

In some wireless communications systems, the spatial distribution of user equipment (UE) within a coverage area or cell may change over time. For example, a geographical area may experience variable network traffic based on different times of the day, times of the week, and different events taking place in the area, among other factors. Upon entering the coverage area of the cell, a UE may perform a contention-based procedure in order to synchronize with the network and to gain access to wireless service. For example, a UE may monitor for synchronization signal blocks (SSBs) transmitted with a set periodicity on different beams from a network entity, and may use a received SSB to perform synchronization measurements and establish a beam pairing for communications with the network.

In some implementations, the network entity may transmit SSBs over each beam with the same set periodicity, and UEs within different areas of the coverage area can receive the SSBs at the set periodicity. In some cases, however, there may be areas in the cell that experience higher traffic than others or may have a relatively higher user density, and thus would benefit from a greater SSB periodicity so that a greater number of UE could perform initial access without performing a lengthy contention procedure due to the high volume of users. Similarly, there may be areas in the network that have relatively low traffic or otherwise relatively low user density, and could operate using a reduced SSB periodicity.

To support efficient communications for wireless networks having variable user density, a network may support a per-beam SSB periodicity that may be dynamically changed based on observed channel conditions. For example, a network entity may configure different SSB periodicities for different beams in an SSB burst transmitted across a cellular coverage area to different UEs. The network entity may observe current channel conditions (e.g., number of channel contentions or relative channel traffic) or may observe statistical trends to determine different periodicities for sending SSBs on different beams. For example, the network entity may transmit SSBs more often (e.g., lower periodicity) during times of high traffic or for areas having high user density, and may increase the SSB periodicity (e.g., transmit SSBs less often) at times of lower traffic or for areas having low user density.

To configure the per-beam SSB periodicity, the network entity may include two fields in a master information block (MIB) transmitted via the physical broadcast channel (PBCH) to UEs for each beam. The first field, ssb-PeriodicityServingBeam, may indicate the periodicity of SSBs on a given beam (e.g., how frequently the network entity transmits SSBs on a given beam). The second field, ssb-PositionsInBurstBeam, may include a bitmap which indicates time locations that a UE is to expect SSBs to be transmitted on a beam. Since a UE receives the MIB for each beam, the network entity may be able to dynamically adapt the SSB periodicities for different beams based on changing network conditions.

Aspects of the disclosure are initially described in the context of wireless communications systems. Aspects of the disclosure are further illustrated by and described with reference to apparatus diagrams, system diagrams, various user distributions over time within wireless networks, a process flow, and flowcharts that relate to dynamic per-beam synchronization signal periodicity.

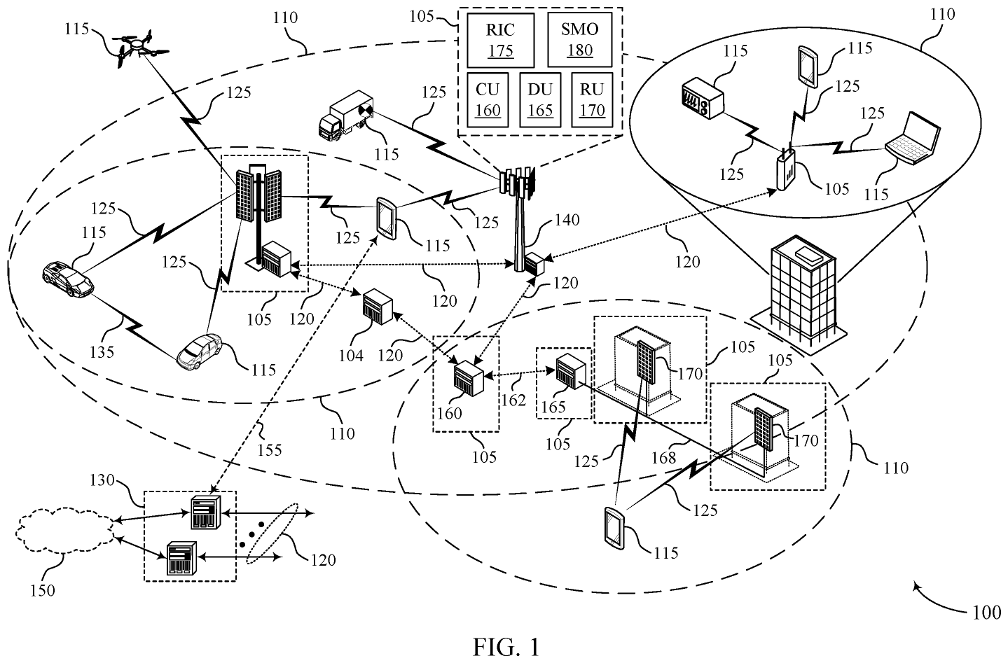

FIG. 1 illustrates an example of a wireless communications system 100 that supports dynamic per-beam synchronization signal periodicity in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support dynamic per-beam synchronization signal periodicity as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MIME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Devices located within wireless communications system 100 may experience changes in spatial distribution over time. For example, the geographical area 110 may experience variable network traffic based on different times and different events taking place in the area, among other factors. Upon entering the coverage area 110, a UE 115 may perform a contention-based procedure in order to synchronize with a network entity 105 and to gain access to wireless service. For example, a UE 115 may monitor for SSBs transmitted with a set periodicity on different beams to establish a beam pairing for communications with the network.

In some implementations, a network entity 105 may transmit SSBs over each beam with the same set periodicity, and UEs within different areas of the coverage area may receive the SSBs according to the set periodicity. In some cases, however, there may be areas that may have a relatively higher UE density, and thus would benefit from a greater number of SSBs per given duration (e.g., lower periodicity) so that a greater number of UE 115 could perform initial access. Similarly, there may be areas in the network that have relatively low UE density, and could operate using a lower number of SSBs per given duration (e.g., higher periodicity).

To support efficient communications for wireless networks having variable user density, a network may support a per-beam SSB periodicity that may be dynamically changed based on observed channel conditions. For example, a network entity 105 may configure different SSB periodicities for different beams in an SSB burst transmitted across a cellular coverage area to different UEs 115. For example, the network entity 105 may transmit SSBs more often (e.g., lower periodicity) during times of high traffic or for areas having high user density, and may increase the SSB periodicity (e.g., transmit SSBs less often) at times of lower traffic or for areas having low user density.

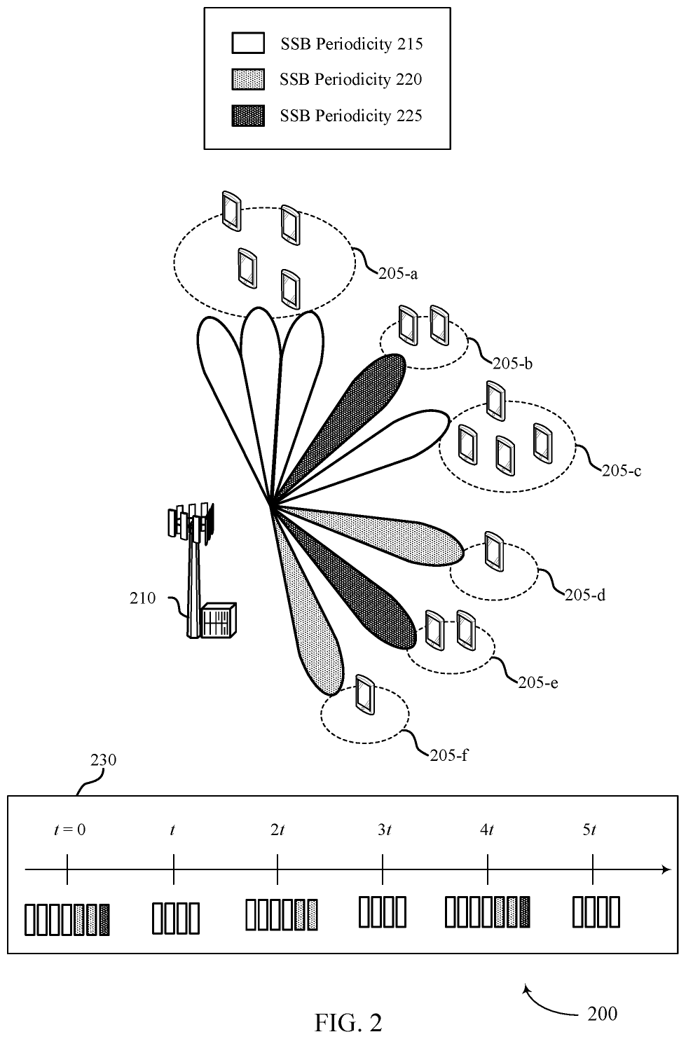

FIG. 2 illustrates an example of a wireless communications system 200 that supports dynamic per-beam synchronization signal periodicity in accordance with one or more aspects of the present disclosure. For example, wireless communications system 200 illustrates beam formed communications between a network entity 210 and various UEs 205, each of which may be examples of network entities 105 and UEs 115 described with reference to FIG. 1.

Wireless communications system 200 may support beam-formed communications between a network entity 210 and a quantity of UEs 205 located within a geographical coverage area or wireless cell served by the network entity 210. In some examples, the wireless communications system 200 may support high frequency communications with operational frequencies that range up to millimeter-wave (mmW), sub-terahertz (subTHz), and beyond. As such operational frequencies increase, the network entity 210 may transmit a relatively greater number of narrow beams (e.g., beam width may decrease linearly as the number of beams increases quadratically). For example, in cases that a 28 giga-Hertz (GHz) frequency system is increased to a 140 GHz frequency system, beam widths may decrease by a factor of one-fifth, which may increase the number of beams by 25 (e.g., 25×) for the same antenna array area.

In some examples, such increases in beam quantity may also increase scanning overhead (e.g., the network entity 210 may scan over many narrow beams) to achieve broad angular coverage instead of relying on wide beams with relatively low gain and energy collection with reduced coverage (e.g., due small effective apertures). To support effective beam management, the wireless communications system 200 may use side information (e.g., GPS, radio access technology (RAT) positioning (sub6, mmW, subTHz), sensor fusion, localized handover information, road traffic control information, etc.) to adaptively or dynamically manage beams in the system.

To perform an initial access procedure to establish and maintain a beam pair link with one or more UEs 205 within the wireless communications system 200, the network entity 210 may perform a beam sweeping procedure by transmitting beams in different directions in a burst. The network entity 210 may transmit SSBs in the burst to UEs 205, and the UEs 205 may receive the SSBs to perform measurements and establish a connection via a beam-pair link. A UE 205 may then apply the established beam-pair link to subsequent transmissions.

In some examples, the number of unique beams per SSB Burst may be equal to Lₘₐₓ=64 for 240 kHz subcarrier spacing. In some other examples, for instance, in sub-THz systems, the subcarrier spacing may be 960 kHz, which may cause the quantity of beams per beam sweep to increase to Lₘₐₓ=256 unique beams with the same beam sweep duration as for Lₘₐₓ=64 for 240 kHz subcarrier spacing. In yet other examples, the network entity 210 may cover an azimuthal section of 60 degrees (with +/−15 degrees elevation) and may transmit beams that span 2 degrees by 2 degrees with 50% overlap. In such examples, the network entity 210 may scan over 1800 beams during a beam scanning procedure, which, using the lowest periodicity (e.g., 5 ms) will take approximately 40 ms to perform the full beam sweep.

In some cases, however, the beam sweeping procedure performed by the network entity 210 may non-uniform across different deployments or regions with higher or lower average user densities. For example, in many wireless communications systems, the spatial distribution of UEs within a given coverage area or cell may change as time elapses. For example, a cell may experience variable traffic based on different times of the day, times of the week, different events taking place in the area, among other factors. Upon entering the coverage area of the cell, a UE 205 may perform a contention-based procedure (e.g., a P1/P2 procedure) to synchronize with the network and to gain access to wireless service. For example, the UEs 205 may monitor for SSBs transmitted on different beams transmitted with a set periodicity from the network entity 210, and may use a received SSB to perform synchronization measurements and establish a connection with the network using a beam pairing.

In some implementations, the network entity 210 may transmit SSBs over each beam with the same set periodicity, and UEs within different areas of the cell (e.g., UEs 205-a, 205-b, 205-c, 205-d, 205-e, and 205-f) can receive the SSBs via beams transmitted from the network entity 210. In some cases, however, there may be areas in the cell that experience higher traffic than others (e.g., UEs 205-a and UEs 205-c may be associated with higher levels of traffic than UEs 205-b, 205-d, 205-e, and 205-f), and thus would benefit from a lower SSB periodicity (e.g., receiving SSBs more often) so that a greater number of users could perform initial acquisition without performing a lengthy contention procedure due to the high volume of users. Similarly, there may be areas in the network that have relatively low traffic (e.g., UEs 205-d and 205-f), and would support increased SSB periodicity (e.g., receiving SSBs less often) based on the relatively few users accessing the channel in those areas.

To support efficient initial access and beam sweeping for SSBs, the network entity 210 may support a per-beam SSB periodicity that may be dynamically changed based on observed channel conditions. For example, the network entity 210 may configure different SSB periodicities for different beams (e.g., first SSB periodicity 215, second SSB periodicity 220, and third SSB periodicity 225) in an SSB burst transmitted across a cellular coverage area to UEs 205. The network entity 210 may observe current channel conditions (e.g., number of channel contentions or relative channel traffic) or may observe statistical trends to determine different periodicities for sending SSBs on different beams (corresponding to different geographical areas of the coverage area). For example, the network entity 210 may observe or obtain user density distribution maps that are learned from statistical behavior of user trends based on time of day (e.g., higher traffic during daytime hours and lower traffic at night), day of the week (e.g., higher or lower traffic rates based on weekday or weekend), holidays, event times, or any combination thereof. The network entity 210 may then be able to send SSBs using certain beam periodicities and with spatial characteristics that may be adapted according to the identified user statistics. For example, the network entity 210 may transmit SSBs more often (e.g., lower periodicity) during times of high traffic, and may increase the SSB periodicity (e.g., transmit SSBs less often) at times of lower traffic.

In wireless communications system 200, for example, the network entity 210 may determine that UEs 205-a and 205-c may be in an area that is experiencing a high traffic rate or may be associated with a relatively high user distribution. Accordingly, the network entity 210 may transmit SSBs to UEs 205-a and 205-c using a first SSB periodicity 215 that may be the lowest periodicity (e.g., SSBs sent every 5 ms). The network entity 210 may also determine that UEs 205-b and 205-e may be in an area that is experiencing a relatively lower traffic rate or relatively lower user distribution. Accordingly, the network entity 210 may transmit SSBs to UEs 205-b and 205-e using a second SSB periodicity 220 that may be a relatively higher periodicity (e.g., SSBs sent every 10 ms). In addition, the network entity 210 may also determine that UEs 205-d and 205-f may be in an area that is experiencing the lowest traffic rate or a relative lowest user distribution. Accordingly, the network entity 210 may transmit SSBs to UEs 205-d and 205-f using a third SSB periodicity 225 that may be the highest periodicity (e.g., SSBs sent every 20 ms).

To configure the per-beam SSB periodicity, the network entity 210 may include two fields in a MIB transmitted via the PBCH to UEs 205 for each beam. The first field, ssb-PeriodicityServingBeam, may indicate the periodicity of SSBs on a given beam (e.g., how frequently the network entity 210 transmits SSBs on a given beam). The second field, ssb-PositionsInBurstBeam, includes a bitmap which indicates time locations that a UE is to expect SSBs to be transmitted on a beam. Since a UE 205 receives the MIB for each beam, the network entity 210 may be able to dynamically adapt the SSB periodicities for different beams based on changing network conditions. For example, the MIB may be updated to include the following information fields:

MIB ::= SEQUENCE {

| | |
|---|---|
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | INTEGER (0..255), |
| cellBarred | ENUMERATED {barred, notBarred}, |
| intraFreqReselection | ENUMERATED {allowed, notAllowed}, |
| ssb-PeriodicityServingBeam | ENUMERATED |

{ms5,ms10,ms20,ms40,ms80,ms160}

| | |
|---|---|
| ssb-PositionsInBurstBeam | BITMAP |
| spare | BIT STRING (SIZE (1)) |

}

In such examples, the fields ssb-PeriodicityServingBeam and ssb-PositionsInBurstBeam may be added to the MIB and corresponding PBCH to support per-beam SSB periodicity indication. The ssb-PeriodicityServingBeam field may include or indicate a time value (e.g., ms5, ms10, ms20, ms40, ms80, ms160, etc.) which may indicate the SSB periodicity for a given beam. For example, the network entity 210 may configure the first SSB periodicity 215 to be equal to ms5 such that the network entity 210 transmits SSBs every 5 ms to UEs 205-a and 205-c. In addition, the network entity 210 may configure the second SSB periodicity 220 to be equal to ms10 such that the network entity 210 transmits SSBs every 10 ms to UEs 205-b and 205-e. Further, the network entity 210 may configure the third SSB periodicity 225 to be equal to ms20 such that the network entity 210 transmits SSBs every 20 ms to UEs 205-d and 205-f In some other examples, the network entity 210 may configure different SSB periodicities for UEs 205 using the ssb-PeriodicityServingBeam field.

The ssb-PositionsInBurstBeam may include a bit map which indicates at which time locations 230 that a UE 205 should expect to receive an SSB. The bitmap may be in the form of the bit field ssb-PositionsInBurst: CHOICE {mediumBitmap 1111000}, where a “1” indicates the presence of an SSB, and a “0” indicates the absence of an SSB at a time location. In some examples, t may be equal to 5 ms, or another time duration. For example, at 0 ms (e.g., t=0), the UE may receive each SSB (e.g., ssb-PositionsInBurstBeam: 11111111), at 5 ms (e.g., t), the UE may receive SSBs with a 5 ms periodicity (e.g., ssb-PositionsInBurstBeam: 11110000), at 10 ms (e.g., 2t), the UE may receive SSBs with a 5 ms periodicity and a 10 ms periodicity (e.g., ssb-PositionsInBurstBeam: 11111100), at 15 ms (e.g., 3t), the UE may receive SSBs with a 5 ms periodicity (e.g., ssb-PositionsInBurstBeam: 11110000), at 20 ms (e.g., 4t), the UE may receive SSBs with a 5 ms periodicity, a 10 ms periodicity, and a 20 ms periodicity (e.g., ssb-PositionsInBurstBeam: 11111111), and at 25 ms (e.g., 5t), the UE may receive SSBs with a 5 ms periodicity (e.g., ssb-PositionsInBurstBeam: 11110000), and so on.

In addition, the network entity 210 may transmit a system information block (SIB) to the UEs 205 which indicates a common serving cell configuration (e.g., ServingCellConfigCommonSIB), an SSB periodicity per serving cell (e.g., ssb-periodicityServingCell), or both, for standalone deployments. Further, for non-standalone deployments, the network entity 210 may include a common serving cell configuration (e.g., ServingCellConfigCommon), the SSB periodicity per serving cell (e.g., ssb-periodicityServingCell), or both, in a radio resource control (RRC) configuration transmitted to the UEs 205.

By implementing a per-beam SSB periodicity, the network may reduce the number of channel contentions (e.g., random access channel (RACH) occasion contention) for high traffic or high user density regions. In addition, the per-beam SSB periodicity may support faster initial acquisition and more efficient beam tracking for most UEs. Additionally or alternatively, the network may be equipped to more dynamically adapt the transmission of SSBs based on observed or predicted channel conditions.

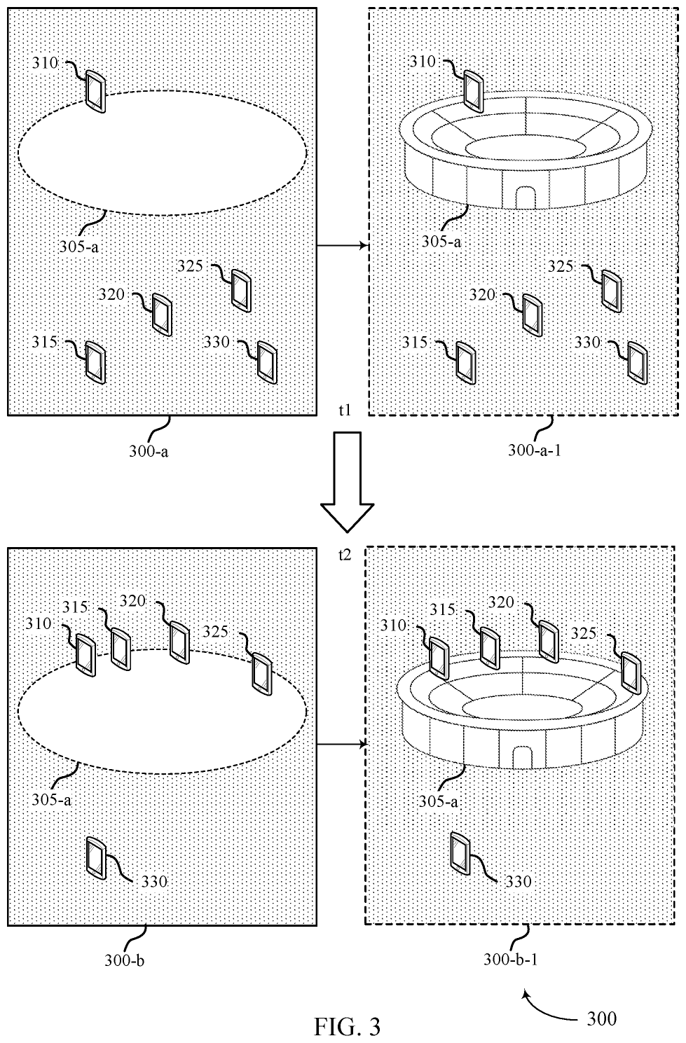

FIG. 3 illustrates an example of a wireless communications system 300 that supports dynamic per-beam synchronization signal periodicity in accordance with one or more aspects of the present disclosure. For example, wireless communications system illustrates various user density configurations including a quantity of UEs, each of which may be an example of UEs 115 described with reference to FIGS. 1 and 2.

Wireless communications system 300 may illustrate example user distribution scenarios within areas 300-a and 300-b, which may show the evolution of the distribution of UEs 310, 315, 320, 325, and 330 over a time period in and around the area 305-a.

The area 300-a may be an example of an area that experiences periods of user density fluctuation over time, for example a stadium, as shown in example 300-a-1. At the beginning of a time period (t1), there may be a relatively low density of users (e.g., UE 310) within the area 305-a, and a relatively high density of users (e.g., UEs 315, 320, 325, and 330) outside of the coverage area (for example, before an event such as a sports game or concert takes place within the stadium).

At some time after the beginning of the time period (t2), there may be a shift in user density such that there may be a relatively high density of users (e.g., UEs 310, 315, 320, and 325) located within the area 305-a, and a relatively low density of users (e.g., UE 330) outside of the area 305-a. 300-b and 300-b-1 may be examples of an area, such as a stadium, after a period of time has elapsed.

In some examples, the UEs may monitor for SSBs transmitted on different beams transmitted with a set periodicity from a network entity within areas 300-a and 300-b, and may use a received SSB to perform synchronization measurements and establish a connection with the network using a beam pairing. To accommodate the shift in user distribution from t1 to t2, however, a network entity may support per-beam SSB periodicity such that the network may send SSBs with a lower periodicity outside of the area 305-a at t1, and then dynamically change to sending SSBs with a lower periodicity within the area 305-a at t2.

For example, a network entity may determine that UE 310 may be in an area that is experiencing low traffic or relatively low channel contention during t1, and that UEs 315, 320, 325, and 330 may be in an area that is experiencing high traffic or relatively high channel contention during t1. Accordingly, the network entity may transmit SSBs to UE 310 at a relatively lower rate than a rate in which it transmits SSBs to the UEs 315, 320, 325, and 330. Then, the network entity may observe a change over time in the user distribution of UEs at t2, and may send SSBs at a more often (e.g., lower periodicity) within the area 305-a as more users enter the area.

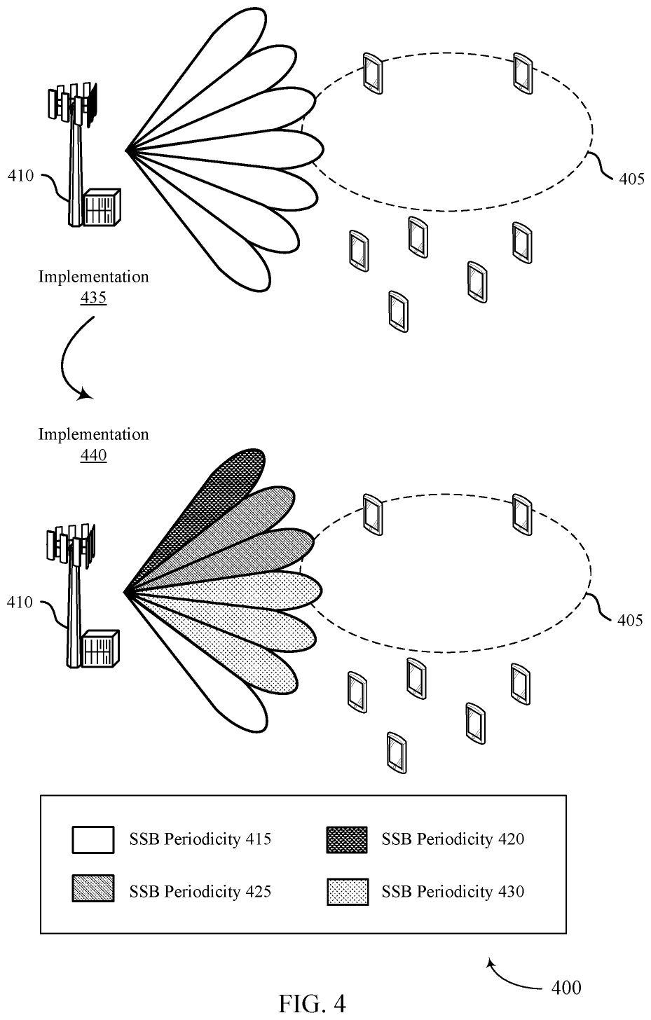

FIG. 4 illustrates an example of a wireless communications system 400 that supports dynamic per-beam synchronization signal periodicity in accordance with one or more aspects of the present disclosure. For example, wireless communications system 400 illustrates beam formed communications between a network entity 410 and various UEs, each of which may be examples of network entities 105 and UEs 115 described with reference to FIGS. 1 and 2.

In a first implementation 435, the network entity 410 may transmit SSBs via a first set of beams in a beam sweep using the same SSB periodicity for each beam (e.g., relatively low SSB periodicity 415). The UEs within event area 405 and outside of event area 405 may then receive the SSBs via beams transmitted from the network entity 410 with the relatively low SSB periodicity 415. In some cases, however, the area outside of event area 405 may experience higher user density and thus would benefit from a greater SSB periodicity so that a greater number of UEs could perform initial acquisition without performing a lengthy contention procedure due to the high volume of users. Similarly, the event area 405 may have relatively low user density and would support a reduced SSB periodicity based on the relatively few users accessing the channel in that area.

To support efficient initial access and beam sweeping for SSBs, the network entity 410 may support implementation 440, which includes a per-beam SSB periodicity that may be dynamically changed based on observed channel conditions. For example, the network entity 410 may configure different SSB periodicities for different beams (e.g., relatively low SSB periodicity 415, highest SSB periodicity 420, relatively high SSB periodicity 425, and lowest SSB periodicity 430) in an SSB burst. The network entity 410 may observe current channel conditions (e.g., number of channel contentions or relative channel traffic) to determine different periodicities for sending SSBs on different beams (corresponding to different geographical areas of the coverage area). For example, the network entity 210 may transmit SSBs with a highest SSB periodicity 420 in areas of low user distribution (e.g., the network entity 210 may transmit SSBs less often), and may transmit SSBs with relatively high SSB periodicity 425 in event area 405 which has relatively low user distribution. The network entity may then transmit SSBs with a lowest SSB periodicity 430 outside of event area 405 (which has a relatively high density of users), and may transmit SSBs with a relatively low SSB periodicity 415 for areas with a relatively high user density (e.g., the network entity 210 may transmit SSBs more often). In the example of implementation 440, the UEs within event area 405 may receive SSBs at a reduced periodicity compared to the set periodicity in the first implementation 435, and the UEs outside of the event area 405 may receive SSBs at an increased rate compared to the set periodicity in the first implementation 435.

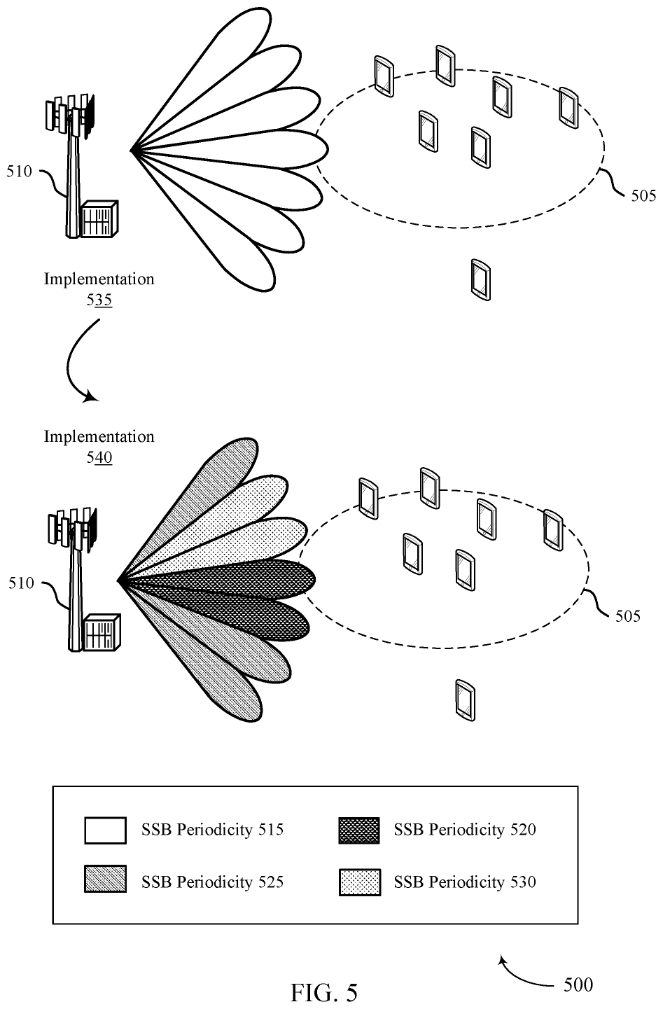

FIG. 5 illustrates an example of a wireless communications system 500 that supports dynamic per-beam synchronization signal periodicity in accordance with one or more aspects of the present disclosure. For example, wireless communications system 500 illustrates beam formed communications between a network entity 510 and various UEs, each of which may be examples of network entities 105 and UEs 115 described with reference to FIGS. 1 and 2.

In a first implementation 535, the network entity 510 may transmit SSBs via a first set of beams in a beam sweep using the same SSB periodicity for each beam (e.g., SSB periodicity 515). The UEs within event area 505 and outside of event area 505 may then receive the SSBs via beams transmitted from the network entity 510 with the SSB periodicity 515. In some cases, however, the area inside of event area 505 may experience higher user density and thus would benefit from a greater SSB periodicity so that a greater number of UEs could perform initial acquisition without performing a lengthy contention procedure due to the high volume of users. Similarly, the area outside of the event area 505 may have relatively low user density and would support a reduced SSB periodicity based on the relatively few users accessing the channel in that area.

To support efficient initial access and beam sweeping for SSBs, the network entity 510 may support implementation 540, which includes a per-beam SSB periodicity that may be dynamically changed based on observed channel conditions. For example, the network entity 510 may configure different SSB periodicities for different beams (e.g., SSB periodicity 515, relatively high SSB periodicity 520, highest SSB periodicity 525, and lowest SSB periodicity 530) in an SSB burst. The network entity 510 may observe current channel conditions (e.g., number of channel contentions or relative channel traffic) to determine different periodicities for sending SSBs on different beams (corresponding to different geographical areas of the coverage area). For example, the network entity 510 may transmit SSBs with a highest SSB periodicity 525 in areas of low user distribution, and may transmit SSBs with a relatively high SSB periodicity 520 outside of the event area 505 which has relatively low user distribution (e.g., the network entity 210 may transmit SSBs less often). The network entity may then transmit SSBs with a lowest SSB periodicity 530 inside of the event area 505 (which has a relatively high density of users), and may transmit SSBs with the highest SSB periodicity 525 for areas with a relatively low user density. In the example of implementation 540, the UEs outside of the event area 505 may receive SSBs at an increased periodicity compared to the set periodicity in the first implementation 535, and the UEs within the event area 505 may receive SSBs at an increased rate compared to the set periodicity in the first implementation 535.

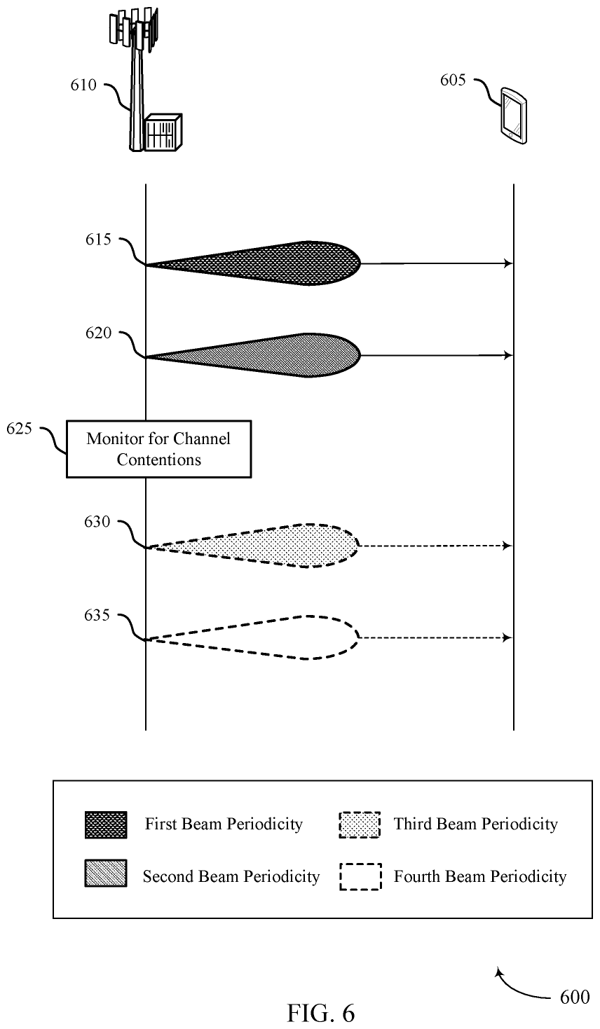

FIG. 6 illustrates an example of a process flow 600 that supports dynamic per-beam synchronization signal periodicity in accordance with one or more aspects of the present disclosure. For example, the process flow 600 illustrates communications between a first wireless device (e.g., a UE 605) and a second wireless device (e.g., a network entity 610). In the following description of the process flow 600, the operations between the UE 605 and the network entity 610 may be communicated in a different order than the example order shown, or the operations performed by the UE 605 and the network entity 610 may be performed in different orders or at different times. Some operations may also be omitted from the process flow 600, and other operations may be added to the process flow 600.

At 615, the network entity 610 may transmit a first SSB associated with a cell supported by the network entity 610 using a first beam. The first SSB may include a first broadcast channel (e.g., PBCH) that indicates a first periodicity for transmission of the first SSB using the first beam.

At 620, the network entity 610 may transmit a second SSB associated with the cell using a second beam. The second SSB may include a second broadcast channel that indicates a second periodicity for transmission of the second SSB associated with the cell using the second beam. In some examples, the second periodicity used to transmit SSBs on the second beam is different from the first periodicity used to transmit SSBs on the second beam.

At 625, the network entity 610 may monitor for a first quantity of channel contentions on a first uplink channel of the cell corresponding to the first beam, and a second quantity of channel contentions on a second uplink channel of the cell corresponding to the second beam. In some cases, the first quantity of channel contentions and the second quantity of channel contentions may correspond to one or more UE (e.g., UE 605) that are attempting to access the first uplink channel and the second uplink channel. Based on the observed first quantity of channel contentions, the network entity 610 may adjust the first periodicity for transmission of the first SSB, and may adjust the second periodicity for transmission of the second SSB based on the observed second quantity of channel contentions. The network entity 610 may then transmit the first SSB at 630 in accordance with the first adjusted periodicity, and may transmit the second SSB at 635 in accordance with the second adjusted periodicity.

In some examples, the network entity 610 may adjust the first periodicity, the second periodicity, or both, based on the first quantity of channel contentions satisfying a threshold number of channel contentions for the first beam, the second quantity of channel contentions satisfying the threshold number of channel contentions for the second beam, or both. In some cases, adjusting the one or more periodicities may include increasing the first periodicity the second periodicity, or both, based on the first quantity of channel contentions being less than the threshold number of channel contentions for the first beam, the second quantity of channel contentions being less than the threshold number of channel contentions for the second beam, or both.

In some examples, the network entity 610 may obtain user density distribution information associated with a spatial distribution of the UE 605 and one or more other UE for one or more time periods. The network entity 610 may then adjust the first periodicity, the second periodicity, or both, in accordance with the user density distribution information, and may transmit the first SSB and the second SSB in accordance with the first and second adjusted periodicities. In some examples, the user density distribution information may be based on a set of statistical user trends observed by the network entity 610 for at least the one or more time periods.

In some cases, the first quantity of channel contentions, the second quantity of channel contentions, or both, change from a first time period to a second time period, and the network entity 610 may adjust the first periodicity, the second periodicity, or both, from the first time period to the second time period.

In some examples, the network entity 610 may transmit a first message via the first broadcast channel that includes a first indication of the first periodicity for transmission of the first SSB using the first beam, and first position information of the first SSB in a corresponding synchronization signal burst. In some cases, the first broadcast channel is a MIB that indicates the first periodicity for transmission of the first SSB associated with the first beam, and the second broadcast channel comprises a second master information block that indicates the second periodicity for transmission of the second SSB associated with the second beam.

Additionally or alternatively, the network entity 610 may transmit a second message via the second broadcast channel that includes a second indication of the second periodicity for transmission of the second SSB using the second beam, and second position information of the second SSB in the corresponding synchronization signal burst. In such examples, the first position information may include a first bitmap indicating locations of the first SSB in the corresponding synchronization signal burst, and the second position information may include a second bitmap indicating locations of the second SSB in the corresponding synchronization signal burst. In addition, the first indication may include one or more fields in the first message which correspond to the first beam and the second indication may include one or more fields in the second message which correspond to the second beam.

In some examples, the network entity 610 may select the first periodicity and the second periodicity from a set of periodicities for transmission of the first SSB and the second SSB. In some other examples, the network entity 610 may transmit, using a third beam, a third SSB associated with the cell supported by the network entity 610. In such examples, the third SSB may include a third broadcast channel that indicates a third periodicity for transmission of the third SSB associated with the cell using the third beam. The third periodicity may in some cases be different from the first periodicity and the second periodicity.

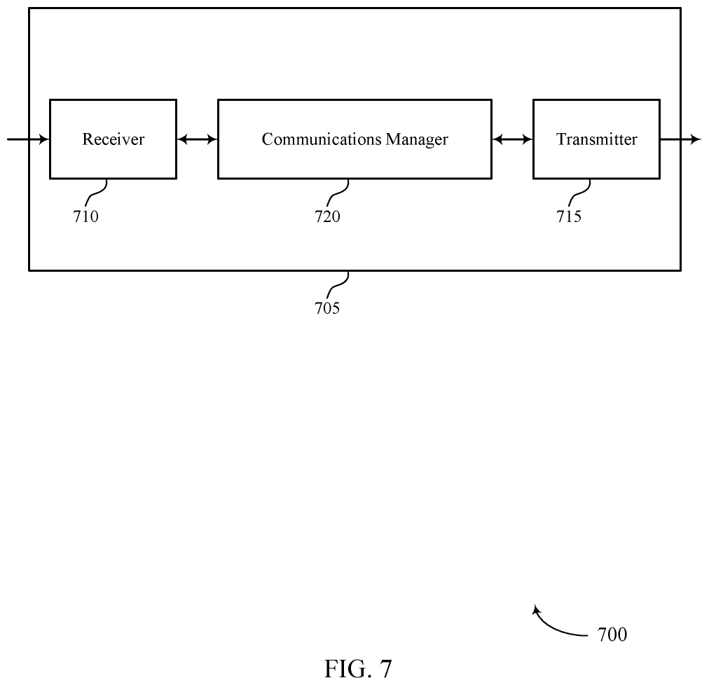

FIG. 7 shows a block diagram 700 of a device 705 that supports dynamic per-beam synchronization signal periodicity in accordance with one or more aspects of the present disclosure. The device 705 may be an example of aspects of a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations thereof or various components thereof may be examples of means for performing various aspects of dynamic per-beam synchronization signal periodicity as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a network entity in accordance with examples as disclosed herein. For example, the communications manager 720 may be configured as or otherwise support a means for transmitting, using a first beam associated with the network entity, a first SSB associated with a cell supported by the network entity, the first SSB including a first broadcast channel that indicates a first periodicity for transmission of the first SSB associated with the cell using the first beam. The communications manager 720 may be configured as or otherwise support a means for transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for relatively faster channel acquisition and channel contention processes, dynamic adaption of deployment according to changing channel conditions, reduced SSB overhead, more efficient network power usage, and more efficient utilization of communication resources.

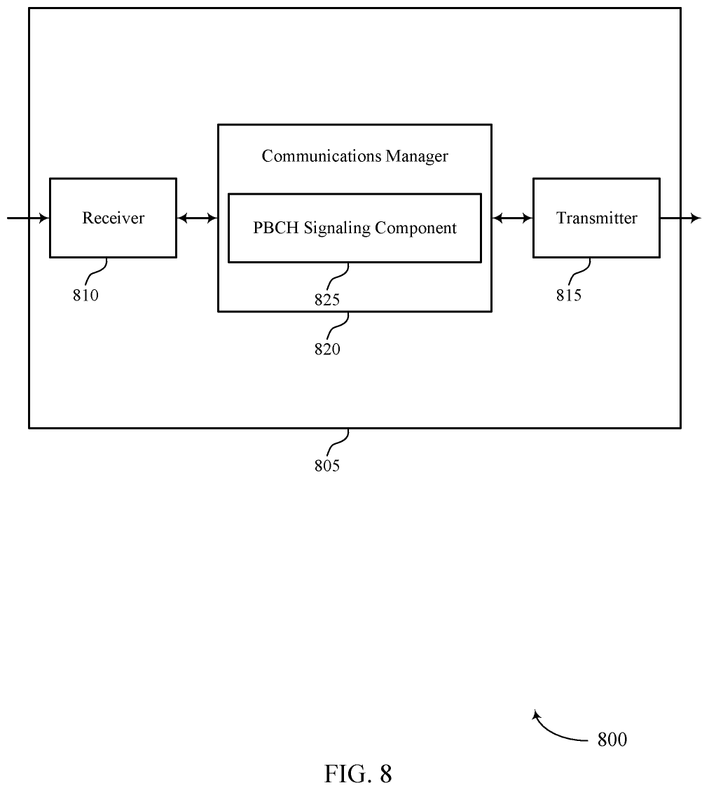

FIG. 8 shows a block diagram 800 of a device 805 that supports dynamic per-beam synchronization signal periodicity in accordance with one or more aspects of the present disclosure. The device 805 may be an example of aspects of a device 705 or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of dynamic per-beam synchronization signal periodicity as described herein. For example, the communications manager 820 may include a PBCH signaling component 825, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. The PBCH signaling component 825 may be configured as or otherwise support a means for transmitting, using a first beam associated with the network entity, a first SSB associated with a cell supported by the network entity, the first SSB including a first broadcast channel that indicates a first periodicity for transmission of the first SSB associated with the cell using the first beam. The PBCH signaling component 825 may be configured as or otherwise support a means for transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity.

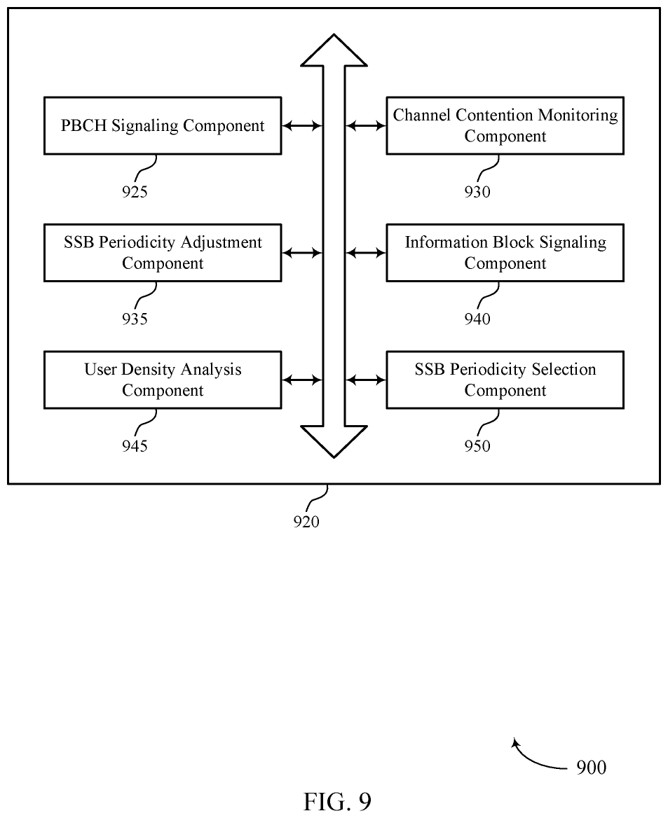

FIG. 9 shows a block diagram 900 of a communications manager 920 that supports dynamic per-beam synchronization signal periodicity in accordance with one or more aspects of the present disclosure. The communications manager 920 may be an example of aspects of a communications manager 720, a communications manager 820, or both, as described herein. The communications manager 920, or various components thereof, may be an example of means for performing various aspects of dynamic per-beam synchronization signal periodicity as described herein. For example, the communications manager 920 may include a PBCH signaling component 925, a channel contention monitoring component 930, an SSB periodicity adjustment component 935, an information block signaling component 940, a user density analysis component 945, an SSB periodicity selection component 950, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communication at a network entity in accordance with examples as disclosed herein. The PBCH signaling component 925 may be configured as or otherwise support a means for transmitting, using a first beam associated with the network entity, a first SSB associated with a cell supported by the network entity, the first SSB including a first broadcast channel that indicates a first periodicity for transmission of the first SSB associated with the cell using the first beam. In some examples, the PBCH signaling component 925 may be configured as or otherwise support a means for transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity.

In some examples, the channel contention monitoring component 930 may be configured as or otherwise support a means for monitoring for a first quantity of channel contentions on a first uplink channel of the cell corresponding to the first beam and a second quantity of channel contentions on a second uplink channel of the cell corresponding to the second beam, the first quantity of channel contentions and the second quantity of channel contentions associated with one or more UE attempting to access the first uplink channel and the second uplink channel. In some examples, the SSB periodicity adjustment component 935 may be configured as or otherwise support a means for adjusting the first periodicity for transmission of the first SSB based on the first quantity of channel contentions. In some examples, the SSB periodicity adjustment component 935 may be configured as or otherwise support a means for adjusting the second periodicity for transmission of the second SSB based on the second quantity of channel contentions. In some examples, the PBCH signaling component 925 may be configured as or otherwise support a means for transmitting the first SSB and the second SSB in accordance with the first adjusted periodicity and the second adjusted periodicity.

In some examples, the SSB periodicity adjustment component 935 may be configured as or otherwise support a means for adjusting the first periodicity, the second periodicity, or both, based on the first quantity of channel contentions satisfying a threshold number of channel contentions for the first beam, the second quantity of channel contentions satisfying the threshold number of channel contentions for the second beam, or both. In some examples, the PBCH signaling component 925 may be configured as or otherwise support a means for transmitting the first SSB and the second SSB in accordance with the first adjusted periodicity and the second adjusted periodicity.

In some examples, the SSB periodicity adjustment component 935 may be configured as or otherwise support a means for decreasing the first periodicity, the second periodicity, or both, based on the first quantity of channel contentions being greater than the threshold number of channel contentions for the first beam, the second quantity of channel contentions being greater than the threshold number of channel contentions for the second beam, or both. In some examples, the PBCH signaling component 925 may be configured as or otherwise support a means for transmitting the first SSB and the second SSB in accordance with the first decreased periodicity and the second decreased periodicity.

In some examples, the SSB periodicity adjustment component 935 may be configured as or otherwise support a means for increasing the first periodicity, the second periodicity, or both, based on the first quantity of channel contentions being less than the threshold number of channel contentions for the first beam, the second quantity of channel contentions being less than the threshold number of channel contentions for the second beam, or both. In some examples, the PBCH signaling component 925 may be configured as or otherwise support a means for transmitting the first SSB and the second SSB in accordance with the first increased periodicity and the second increased periodicity.

In some examples, the user density analysis component 945 may be configured as or otherwise support a means for obtaining user density distribution information associated with a spatial distribution of the one or more UE for one or more time periods. In some examples, the SSB periodicity adjustment component 935 may be configured as or otherwise support a means for adjusting the first periodicity, the second periodicity, or both, in accordance with the user density distribution information. In some examples, the PBCH signaling component 925 may be configured as or otherwise support a means for transmitting the first SSB and the second SSB in accordance with the first adjusted periodicity and the second adjusted periodicity.

In some examples, the user density analysis component 945 may be configured as or otherwise support a means for obtaining the user density distribution information based on a set of statistical user trends observed by the network entity for at least the one or more time periods.

In some examples, the first quantity of channel contentions, and the SSB periodicity adjustment component 935 may be configured as or otherwise support a means for adjusting the first periodicity, the second periodicity, or both, during the second time period based on the change in the first quantity of channel contentions, the change in the second quantity of channel contentions, or both. In some examples, the first quantity of channel contentions, and the PBCH signaling component 925 may be configured as or otherwise support a means for transmitting the first SSB and the second SSB in accordance with the first adjusted periodicity and the second adjusted periodicity.

In some examples, the information block signaling component 940 may be configured as or otherwise support a means for transmitting, via the first broadcast channel, a first message including a first indication of the first periodicity for transmission of the first SSB using the first beam, and first position information of the first SSB in a corresponding synchronization signal burst. In some examples, the information block signaling component 940 may be configured as or otherwise support a means for transmitting, via the second broadcast channel, a second message including a second indication of the second periodicity for transmission of the second SSB using the second beam, and second position information of the second SSB in the corresponding synchronization signal burst.

In some examples, the first position information includes a first bitmap indicating locations of the first SSB in the corresponding synchronization signal burst, and the second position information includes a second bitmap indicating locations of the second SSB in the corresponding synchronization signal burst.

In some examples, the first indication includes one or more fields in the first message corresponding to the first beam and the second indication includes one or more fields in the second message corresponding to the second beam.

In some examples, the SSB periodicity selection component 950 may be configured as or otherwise support a means for selecting the first periodicity and the second periodicity from a set of periodicities for transmission of the first SSB and the second SSB. In some examples, the PBCH signaling component 925 may be configured as or otherwise support a means for transmitting the first message including the selected first periodicity and the second message including the selected second periodicity.

In some examples, the first broadcast channel includes a first master information block that indicates the first periodicity for transmission of the first SSB associated with the first beam, and the second broadcast channel includes a second master information block that indicates the second periodicity for transmission of the second SSB associated with the second beam.

In some examples, the PBCH signaling component 925 may be configured as or otherwise support a means for transmitting, using a third beam associated with the network entity, a third SSB associated with the cell supported by the network entity, the third SSB including a third broadcast channel that indicates a third periodicity for transmission of the third SSB associated with the cell using the third beam, the third periodicity being different from the first periodicity and the second periodicity.

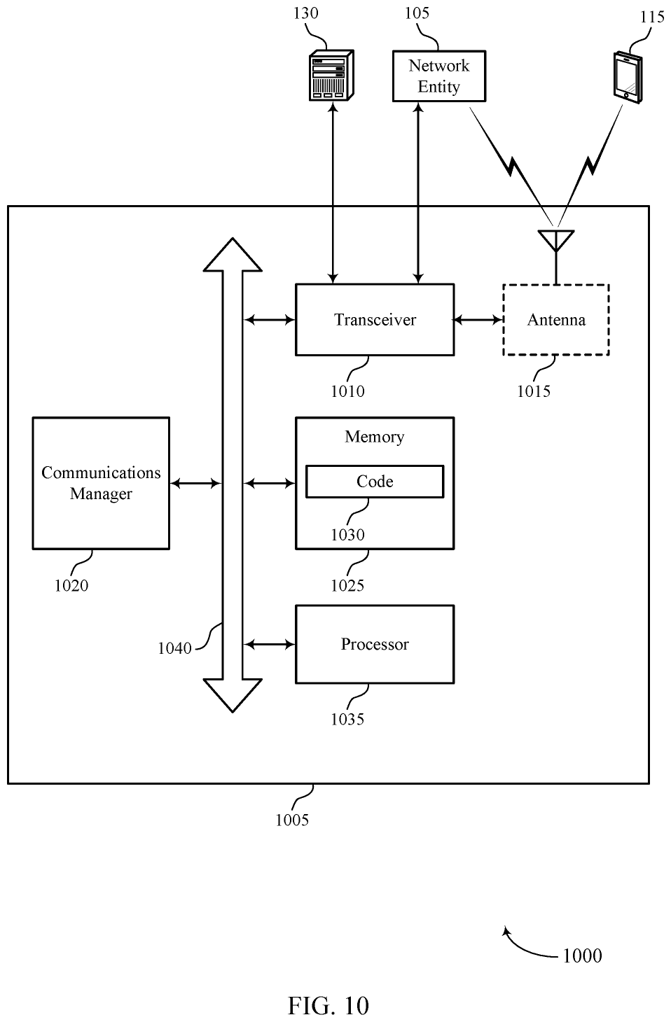

FIG. 10 shows a diagram of a system 1000 including a device 1005 that supports dynamic per-beam synchronization signal periodicity in accordance with one or more aspects of the present disclosure. The device 1005 may be an example of or include the components of a device 705, a device 805, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting dynamic per-beam synchronization signal periodicity). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communication at a network entity in accordance with examples as disclosed herein. For example, the communications manager 1020 may be configured as or otherwise support a means for transmitting, using a first beam associated with the network entity, a first SSB associated with a cell supported by the network entity, the first SSB including a first broadcast channel that indicates a first periodicity for transmission of the first SSB associated with the cell using the first beam. The communications manager 1020 may be configured as or otherwise support a means for transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity.

By including or configuring the communications manager 1020 in accordance with examples as described herein, the device 1005 may support techniques for improved communication reliability, reduced latency, improved user experience related to reduced processing, relatively faster channel acquisition and channel contention processes, dynamic adaption of deployment according to changing channel conditions, reduced SSB overhead, more efficient network power usage, improved coordination between wireless devices, and more efficient utilization of communication resources.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, the processor 1035, the memory 1025, the code 1030, or any combination thereof. For example, the code 1030 may include instructions executable by the processor 1035 to cause the device 1005 to perform various aspects of dynamic per-beam synchronization signal periodicity as described herein, or the processor 1035 and the memory 1025 may be otherwise configured to perform or support such operations.

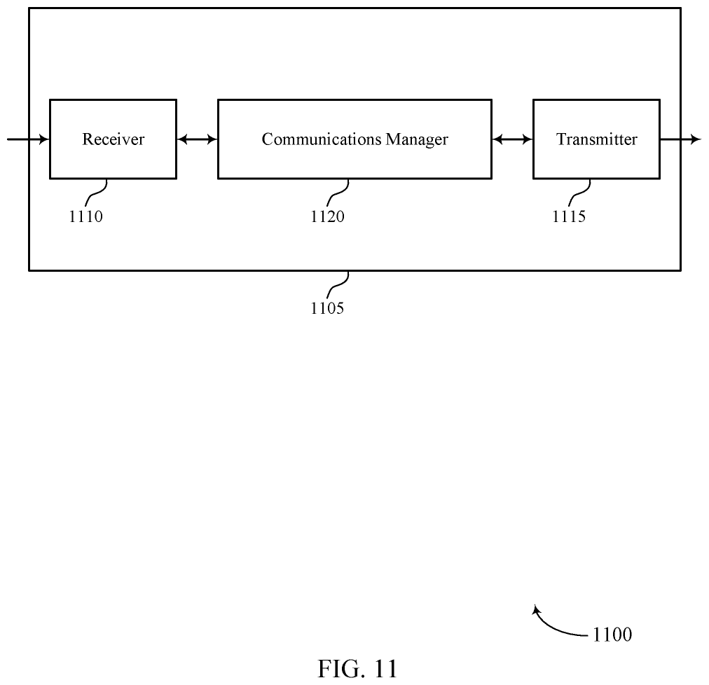

FIG. 11 shows a block diagram 1100 of a device 1105 that supports dynamic per-beam synchronization signal periodicity in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to dynamic per-beam synchronization signal periodicity). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to dynamic per-beam synchronization signal periodicity). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of dynamic per-beam synchronization signal periodicity as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a UE in accordance with examples as disclosed herein. For example, the communications manager 1120 may be configured as or otherwise support a means for receiving a first synchronization signal and a second synchronization signal including time and frequency synchronization information for communications on a cell supported by a network entity. The communications manager 1120 may be configured as or otherwise support a means for receiving a first SSB associated with the cell, the first SSB including a first broadcast channel that indicates a first beam-specific periodicity associated with transmission of the first SSB via a first beam.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for relatively faster channel acquisition and channel contention processes, dynamic adaption of deployment according to changing channel conditions, reduced SSB overhead, more efficient network power usage, and more efficient utilization of communication resources.

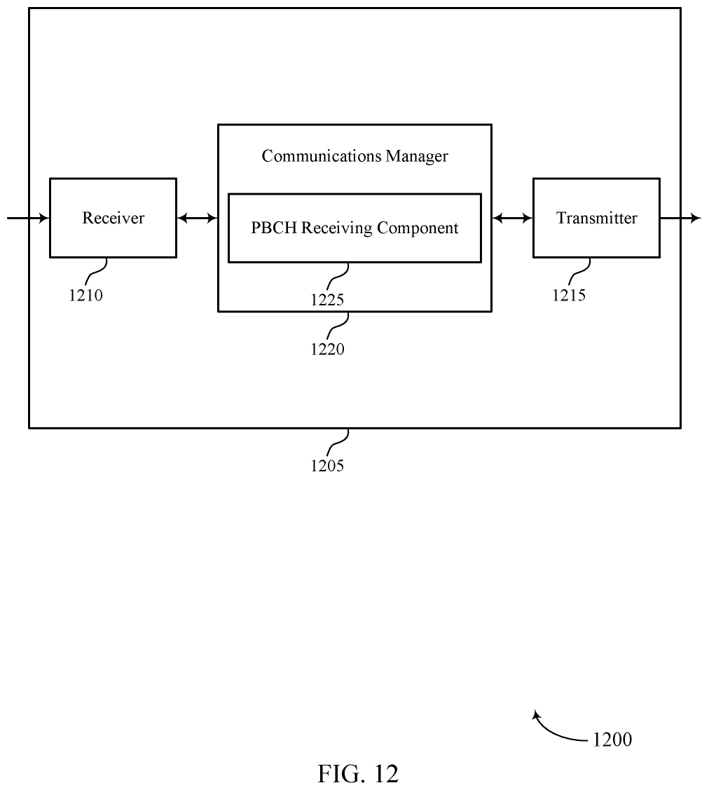

FIG. 12 shows a block diagram 1200 of a device 1205 that supports dynamic per-beam synchronization signal periodicity in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to dynamic per-beam synchronization signal periodicity). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to dynamic per-beam synchronization signal periodicity). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of dynamic per-beam synchronization signal periodicity as described herein. For example, the communications manager 1220 may include a PBCH receiving component 1225, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a UE in accordance with examples as disclosed herein. The PBCH receiving component 1225 may be configured as or otherwise support a means for receiving a first synchronization signal and a second synchronization signal including time and frequency synchronization information for communications on a cell supported by a network entity. The PBCH receiving component 1225 may be configured as or otherwise support a means for receiving a first SSB associated with the cell, the first SSB including a first broadcast channel that indicates a first beam-specific periodicity associated with transmission of the first SSB via a first beam.

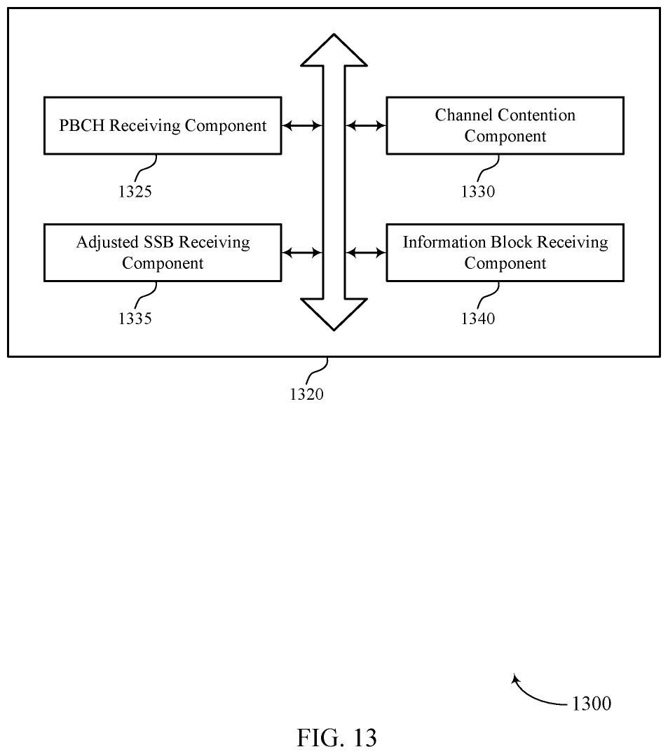

FIG. 13 shows a block diagram 1300 of a communications manager 1320 that supports dynamic per-beam synchronization signal periodicity in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of dynamic per-beam synchronization signal periodicity as described herein. For example, the communications manager 1320 may include a PBCH receiving component 1325, a channel contention component 1330, an adjusted SSB receiving component 1335, an information block receiving component 1340, or any combination thereof. Each of these components may communicate, directly or indirectly, with one another (e.g., via one or more buses).

The communications manager 1320 may support wireless communication at a UE in accordance with examples as disclosed herein. The PBCH receiving component 1325 may be configured as or otherwise support a means for receiving a first synchronization signal and a second synchronization signal including time and frequency synchronization information for communications on a cell supported by a network entity. In some examples, the PBCH receiving component 1325 may be configured as or otherwise support a means for receiving a first SSB associated with the cell, the first SSB including a first broadcast channel that indicates a first beam-specific periodicity associated with transmission of the first SSB via a first beam.

In some examples, the channel contention component 1330 may be configured as or otherwise support a means for performing a first quantity of channel contentions on a first uplink channel of the cell corresponding to the first beam. In some examples, the adjusted SSB receiving component 1335 may be configured as or otherwise support a means for receiving an adjusted first beam-specific periodicity for transmission of the first SSB based on the first quantity of channel contentions.

In some examples, the adjusted first beam-specific periodicity is based on the first quantity of channel contentions satisfying a threshold number of channel contentions for the first beam.

In some examples, the adjusted SSB receiving component 1335 may be configured as or otherwise support a means for receiving a decreased first beam-specific periodicity based on the first quantity of channel contentions being greater than the threshold number of channel contentions for the first beam.

In some examples, the adjusted SSB receiving component 1335 may be configured as or otherwise support a means for receiving an increased first beam-specific periodicity based on the first quantity of channel contentions being less than the threshold number of channel contentions for the first beam.

In some examples, the adjusted first beam-specific periodicity is based on user density distribution information associated with a spatial distribution of the UE and one or more UE for one or more time periods.

In some examples, the adjusted first beam-specific periodicity is based on a change in the first quantity of channel contentions during a first time period.

In some examples, the information block receiving component 1340 may be configured as or otherwise support a means for receiving, via the first broadcast channel, a first message including a first indication of the first beam-specific periodicity for transmission of the first SSB using the first beam, and first position information of the first SSB in a corresponding synchronization signal burst.

In some examples, the first position information includes a first bitmap indicating locations of the first SSB in the corresponding synchronization signal burst.

In some examples, the first indication includes one or more fields in the first message corresponding to the first beam.

In some examples, the PBCH receiving component 1325 may be configured as or otherwise support a means for receiving the first message including the first beam-specific periodicity indicated from a set of periodicities for transmission of the first SSB.

In some examples, the first broadcast channel includes a first master information block that indicates the first beam-specific periodicity for transmission of the first SSB associated with the first beam.

In some examples, the PBCH receiving component 1325 may be configured as or otherwise support a means for receiving, using a second beam associated with the network entity, a second SSB associated with the cell that corresponds to the UE, the second SSB including a second broadcast channel that indicates a second beam-specific periodicity for reception of the second SSB associated with the cell using the second beam, the second beam-specific periodicity being different from the first beam-specific periodicity.

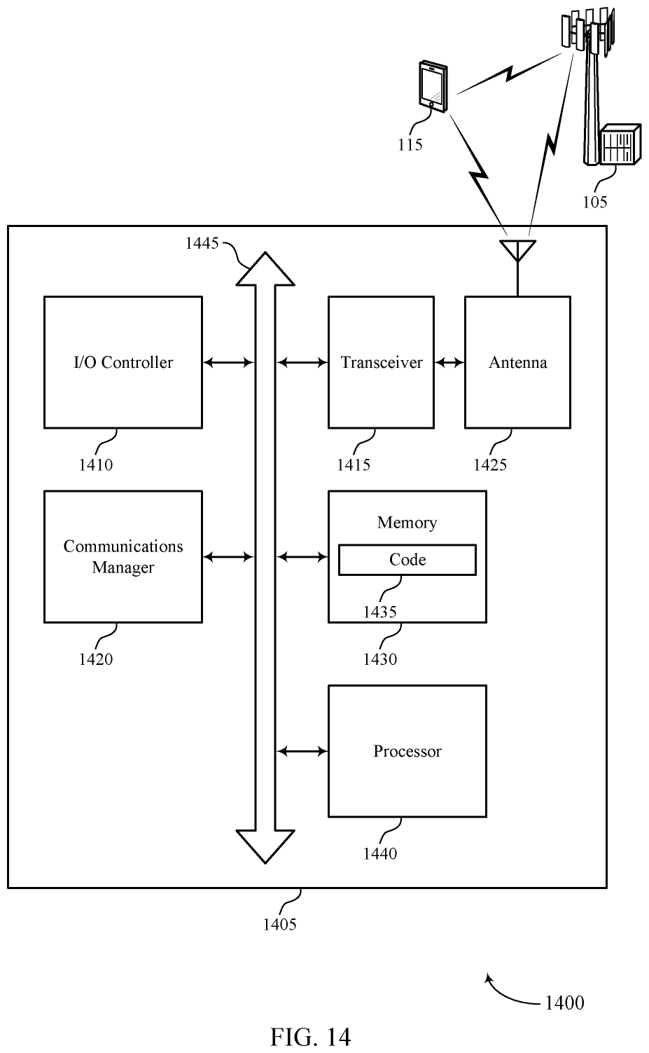

FIG. 14 shows a diagram of a system 1400 including a device 1405 that supports dynamic per-beam synchronization signal periodicity in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting dynamic per-beam synchronization signal periodicity). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communication at a UE in accordance with examples as disclosed herein. For example, the communications manager 1420 may be configured as or otherwise support a means for receiving a first synchronization signal and a second synchronization signal including time and frequency synchronization information for communications on a cell supported by a network entity. The communications manager 1420 may be configured as or otherwise support a means for receiving a first SSB associated with the cell, the first SSB including a first broadcast channel that indicates a first beam-specific periodicity associated with transmission of the first SSB via a first beam.

By including or configuring the communications manager 1420 in accordance with examples as described herein, the device 1405 may support techniques for improved communication reliability, reduced latency, improved user experience related to reduced processing, relatively faster channel acquisition and channel contention processes, dynamic adaption of deployment according to changing channel conditions, reduced SSB overhead, more efficient network power usage, improved coordination between wireless devices, and more efficient utilization of communication resources.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of dynamic per-beam synchronization signal periodicity as described herein, or the processor 1440 and the memory 1430 may be otherwise configured to perform or support such operations.

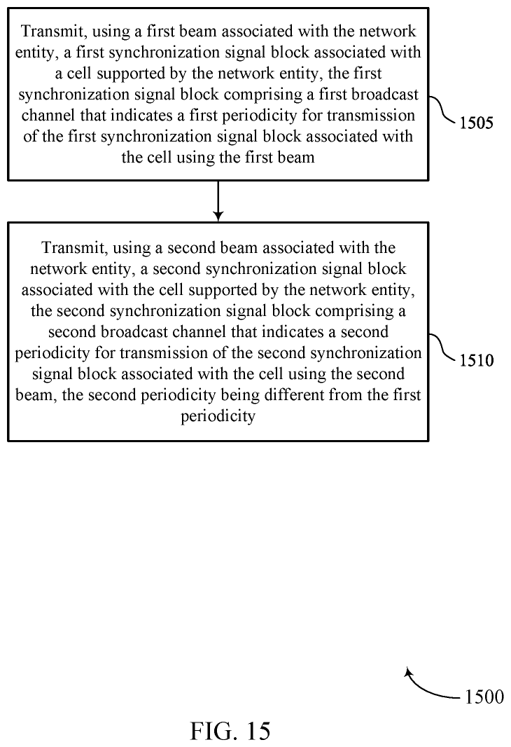

FIG. 15 shows a flowchart illustrating a method 1500 that supports dynamic per-beam synchronization signal periodicity in accordance with one or more aspects of the present disclosure. The operations of the method 1500 may be implemented by a network entity or its components as described herein. For example, the operations of the method 1500 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, using a first beam associated with the network entity, a first SSB associated with a cell supported by the network entity, the first SSB including a first broadcast channel that indicates a first periodicity for transmission of the first SSB associated with the cell using the first beam. The operations of 1505 may be performed in accordance with examples as disclosed herein. In some examples, aspects of the operations of 1505 may be performed by a PBCH signaling component 925 as described with reference to FIG. 9.

At 1510, the method may include transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity. The operations of 1510 may be performed in accordance with examples as disclosed herein. In some examples, aspects of the operations of 1510 may be performed by a PBCH signaling component 925 as described with reference to FIG. 9.

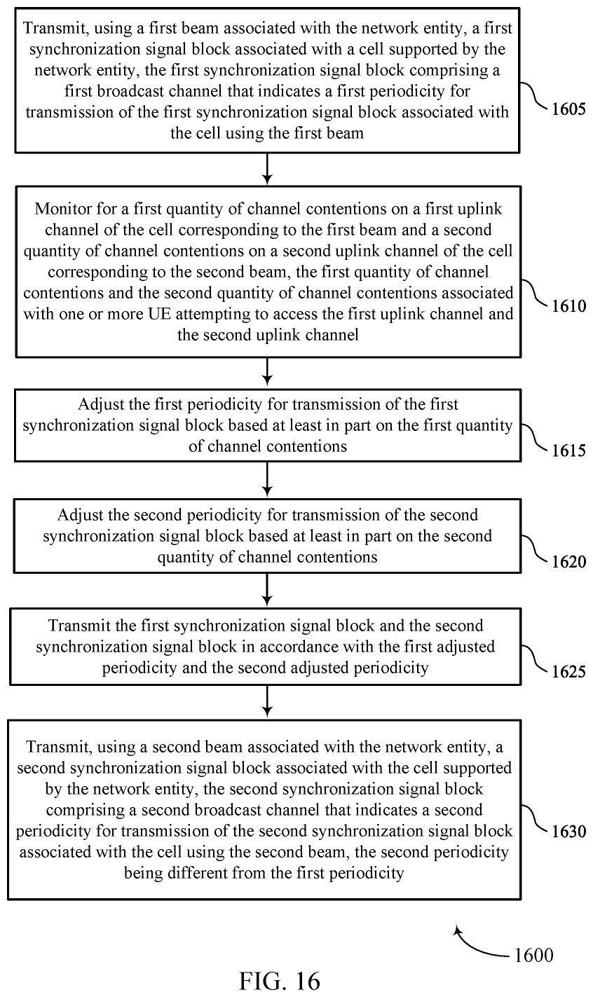

FIG. 16 shows a flowchart illustrating a method 1600 that supports dynamic per-beam synchronization signal periodicity in accordance with one or more aspects of the present disclosure. The operations of the method 1600 may be implemented by a network entity or its components as described herein. For example, the operations of the method 1600 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, using a first beam associated with the network entity, a first SSB associated with a cell supported by the network entity, the first SSB including a first broadcast channel that indicates a first periodicity for transmission of the first SSB associated with the cell using the first beam. The operations of 1605 may be performed in accordance with examples as disclosed herein. In some examples, aspects of the operations of 1605 may be performed by a PBCH signaling component 925 as described with reference to FIG. 9.

At 1610, the method may include monitoring for a first quantity of channel contentions on a first uplink channel of the cell corresponding to the first beam and a second quantity of channel contentions on a second uplink channel of the cell corresponding to the second beam, the first quantity of channel contentions and the second quantity of channel contentions associated with one or more UE attempting to access the first uplink channel and the second uplink channel. The operations of 1610 may be performed in accordance with examples as disclosed herein. In some examples, aspects of the operations of 1610 may be performed by a channel contention monitoring component 930 as described with reference to FIG. 9.

At 1615, the method may include adjusting the first periodicity for transmission of the first SSB based on the first quantity of channel contentions. The operations of 1615 may be performed in accordance with examples as disclosed herein. In some examples, aspects of the operations of 1615 may be performed by an SSB periodicity adjustment component 935 as described with reference to FIG. 9.

At 1620, the method may include adjusting the second periodicity for transmission of the second SSB based on the second quantity of channel contentions. The operations of 1620 may be performed in accordance with examples as disclosed herein. In some examples, aspects of the operations of 1620 may be performed by an SSB periodicity adjustment component 935 as described with reference to FIG. 9.

At 1625, the method may include transmitting the first SSB and the second SSB in accordance with the first adjusted periodicity and the second adjusted periodicity. The operations of 1625 may be performed in accordance with examples as disclosed herein. In some examples, aspects of the operations of 1625 may be performed by a PBCH signaling component 925 as described with reference to FIG. 9.

At 1630, the method may include transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity. The operations of 1630 may be performed in accordance with examples as disclosed herein. In some examples, aspects of the operations of 1630 may be performed by a PBCH signaling component 925 as described with reference to FIG. 9.

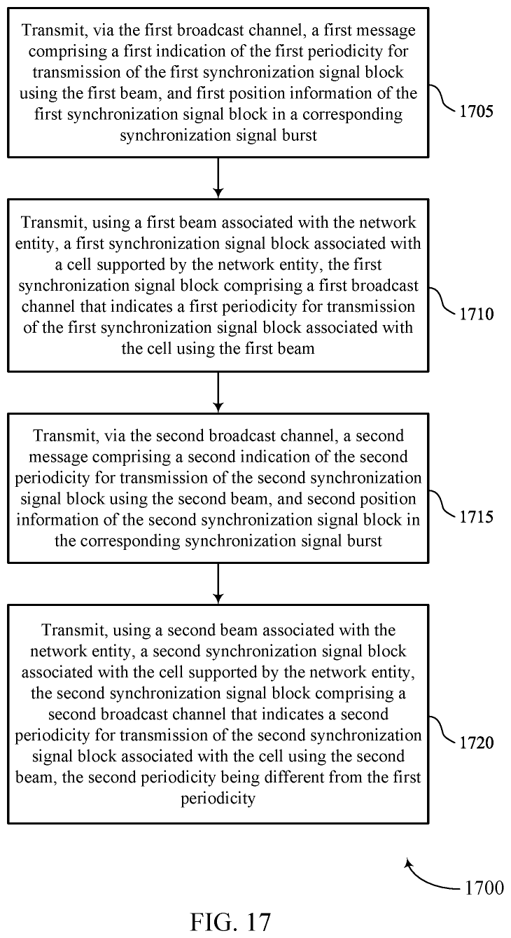

FIG. 17 shows a flowchart illustrating a method 1700 that supports dynamic per-beam synchronization signal periodicity in accordance with one or more aspects of the present disclosure. The operations of the method 1700 may be implemented by a network entity or its components as described herein. For example, the operations of the method 1700 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, via the first broadcast channel, a first message including a first indication of the first periodicity for transmission of the first SSB using the first beam, and first position information of the first SSB in a corresponding synchronization signal burst. The operations of 1705 may be performed in accordance with examples as disclosed herein. In some examples, aspects of the operations of 1705 may be performed by an information block signaling component 940 as described with reference to FIG. 9.

At 1710, the method may include transmitting, using a first beam associated with the network entity, a first SSB associated with a cell supported by the network entity, the first SSB including a first broadcast channel that indicates a first periodicity for transmission of the first SSB associated with the cell using the first beam. The operations of 1710 may be performed in accordance with examples as disclosed herein. In some examples, aspects of the operations of 1710 may be performed by a PBCH signaling component 925 as described with reference to FIG. 9.

At 1715, the method may include transmitting, via the second broadcast channel, a second message including a second indication of the second periodicity for transmission of the second SSB using the second beam, and second position information of the second SSB in the corresponding synchronization signal burst. The operations of 1715 may be performed in accordance with examples as disclosed herein. In some examples, aspects of the operations of 1715 may be performed by an information block signaling component 940 as described with reference to FIG. 9.

At 1720, the method may include transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity. The operations of 1720 may be performed in accordance with examples as disclosed herein. In some examples, aspects of the operations of 1720 may be performed by a PBCH signaling component 925 as described with reference to FIG. 9.

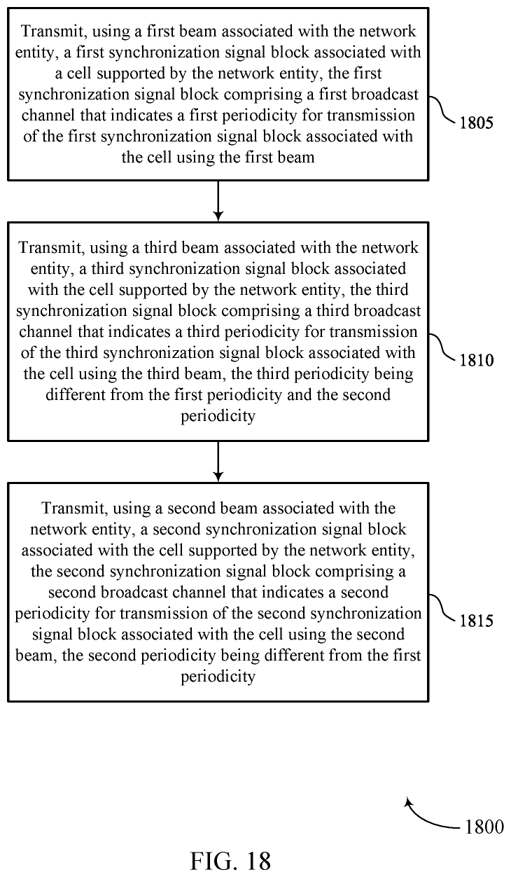

FIG. 18 shows a flowchart illustrating a method 1800 that supports dynamic per-beam synchronization signal periodicity in accordance with one or more aspects of the present disclosure. The operations of the method 1800 may be implemented by a network entity or its components as described herein. For example, the operations of the method 1800 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, using a first beam associated with the network entity, a first SSB associated with a cell supported by the network entity, the first SSB including a first broadcast channel that indicates a first periodicity for transmission of the first SSB associated with the cell using the first beam. The operations of 1805 may be performed in accordance with examples as disclosed herein. In some examples, aspects of the operations of 1805 may be performed by a PBCH signaling component 925 as described with reference to FIG. 9.

At 1810, the method may include transmitting, using a third beam associated with the network entity, a third SSB associated with the cell supported by the network entity, the third SSB including a third broadcast channel that indicates a third periodicity for transmission of the third SSB associated with the cell using the third beam, the third periodicity being different from the first periodicity and the second periodicity. The operations of 1810 may be performed in accordance with examples as disclosed herein. In some examples, aspects of the operations of 1810 may be performed by a PBCH signaling component 925 as described with reference to FIG. 9.

At 1815, the method may include transmitting, using a second beam associated with the network entity, a second SSB associated with the cell supported by the network entity, the second SSB including a second broadcast channel that indicates a second periodicity for transmission of the second SSB associated with the cell using the second beam, the second periodicity being different from the first periodicity. The operations of 1815 may be performed in accordance with examples as disclosed herein. In some examples, aspects of the operations of 1815 may be performed by a PBCH signaling component 925 as described with reference to FIG. 9.

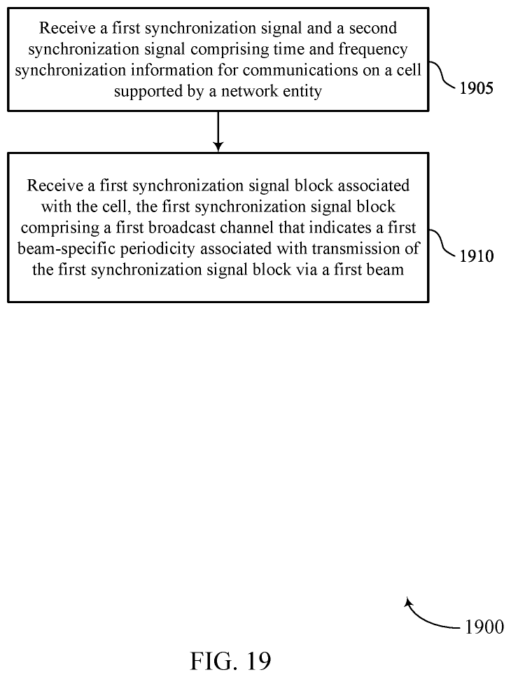

FIG. 19 shows a flowchart illustrating a method 1900 that supports dynamic per-beam synchronization signal periodicity in accordance with one or more aspects of the present disclosure. The operations of the method 1900 may be implemented by a UE or its components as described herein. For example, the operations of the method 1900 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1905, the method may include receiving a first synchronization signal and a second synchronization signal including time and frequency synchronization information for communications on a cell supported by a network entity. The operations of 1905 may be performed in accordance with examples as disclosed herein. In some examples, aspects of the operations of 1905 may be performed by a PBCH receiving component 1325 as described with reference to FIG. 13.

At 1910, the method may include receiving a first SSB associated with the cell, the first SSB including a first broadcast channel that indicates a first beam-specific periodicity associated with transmission of the first SSB via a first beam. The operations of 1910 may be performed in accordance with examples as disclosed herein. In some examples, aspects of the operations of 1910 may be performed by a PBCH receiving component 1325 as described with reference to FIG. 13.

The following provides an overview of aspects of the present disclosure:

Aspect 1: A method for wireless communication at a network entity, comprising: transmitting, using a first beam associated with the network entity, a first SSB associated with a cell supported by the network entity, the first SSB comprising a first broadcast channel that indicates a first periodicity for transmission of the first SSB associated with the cell using the first beam; and transmitting, using a second beam associated with the network entity, a second SSB associated with the cell supported by the network entity, the second SSB comprising a second broadcast channel that indicates a second periodicity for transmission of the second SSB associated with the cell using the second beam, the second periodicity being different from the first periodicity.

Aspect 2: The method of aspect 1, further comprising: monitoring for a first quantity of channel contentions on a first uplink channel of the cell corresponding to the first beam and a second quantity of channel contentions on a second uplink channel of the cell corresponding to the second beam, the first quantity of channel contentions and the second quantity of channel contentions associated with one or more UE attempting to access the first uplink channel and the second uplink channel; adjusting the first periodicity for transmission of the first SSB based at least in part on the first quantity of channel contentions; adjusting the second periodicity for transmission of the second SSB based at least in part on the second quantity of channel contentions; and transmitting the first SSB and the second SSB in accordance with the first adjusted periodicity and the second adjusted periodicity.

Aspect 3: The method of aspect 2, further comprising: adjusting the first periodicity, the second periodicity, or both, based at least in part on the first quantity of channel contentions satisfying a threshold number of channel contentions for the first beam, the second quantity of channel contentions satisfying the threshold number of channel contentions for the second beam, or both; and transmitting the first SSB and the second SSB in accordance with the first adjusted periodicity and the second adjusted periodicity.

Aspect 4: The method of aspect 3, wherein adjusting the first periodicity, the second periodicity, or both further comprises: decreasing the first periodicity, the second periodicity, or both, based at least in part on the first quantity of channel contentions being greater than the threshold number of channel contentions for the first beam, the second quantity of channel contentions being greater than the threshold number of channel contentions for the second beam, or both; and transmitting the first SSB and the second SSB in accordance with the first decreased periodicity and the second decreased periodicity.

Aspect 5: The method of any of aspects 3 through 4, wherein adjusting the first periodicity, the second periodicity, or both further comprises: increasing the first periodicity, the second periodicity, or both, based at least in part on the first quantity of channel contentions being less than the threshold number of channel contentions for the first beam, the second quantity of channel contentions being less than the threshold number of channel contentions for the second beam, or both; and transmitting the first SSB and the second SSB in accordance with the first increased periodicity and the second increased periodicity.

Aspect 6: The method of any of aspects 2 through 5, further comprising: obtaining user density distribution information associated with a spatial distribution of the one or more UE for one or more time periods; adjusting the first periodicity, the second periodicity, or both, in accordance with the user density distribution information; and transmitting the first SSB and the second SSB in accordance with the first adjusted periodicity and the second adjusted periodicity.

Aspect 7: The method of aspect 6, further comprising: obtaining the user density distribution information based at least in part on a set of statistical user trends observed by the network entity for at least the one or more time periods.

Aspect 8: The method of any of aspects 2 through 7, wherein the first quantity of channel contentions, the second quantity of channel contentions, or both, change from a first time period to a second time period, the method further comprising: adjusting the first periodicity, the second periodicity, or both, during the second time period based at least in part on the change in the first quantity of channel contentions, the change in the second quantity of channel contentions, or both; and transmitting the first SSB and the second SSB in accordance with the first adjusted periodicity and the second adjusted periodicity.

Aspect 9: The method of any of aspects 1 through 8, further comprising: transmitting, via the first broadcast channel, a first message comprising a first indication of the first periodicity for transmission of the first SSB using the first beam, and first position information of the first SSB in a corresponding synchronization signal burst; and transmitting, via the second broadcast channel, a second message comprising a second indication of the second periodicity for transmission of the second SSB using the second beam, and second position information of the second SSB in the corresponding synchronization signal burst.

Aspect 10: The method of aspect 9, wherein the first position information comprises a first bitmap indicating locations of the first SSB in the corresponding synchronization signal burst, and the second position information comprises a second bitmap indicating locations of the second SSB in the corresponding synchronization signal burst.

Aspect 11: The method of any of aspects 9 through 10, wherein the first indication comprises one or more fields in the first message corresponding to the first beam and the second indication comprises one or more fields in the second message corresponding to the second beam.

Aspect 12: The method of any of aspects 9 through 11, further comprising: selecting the first periodicity and the second periodicity from a set of periodicities for transmission of the first SSB and the second SSB; and transmitting the first message comprising the selected first periodicity and the second message comprising the selected second periodicity.

Aspect 13: The method of any of aspects 1 through 12, wherein the first broadcast channel comprises a first MIB that indicates the first periodicity for transmission of the first SSB associated with the first beam, and the second broadcast channel comprises a second MIB that indicates the second periodicity for transmission of the second SSB associated with the second beam.

Aspect 14: The method of any of aspects 1 through 13, further comprising: transmitting, using a third beam associated with the network entity, a third SSB associated with the cell supported by the network entity, the third SSB comprising a third broadcast channel that indicates a third periodicity for transmission of the third SSB associated with the cell using the third beam, the third periodicity being different from the first periodicity and the second periodicity.

Aspect 15: A method for wireless communication at a UE, comprising: receiving a first synchronization signal and a second synchronization signal comprising time and frequency synchronization information for communications on a cell supported by a network entity; and receiving a first SSB associated with the cell, the first SSB comprising a first broadcast channel that indicates a first beam-specific periodicity associated with transmission of the first SSB via a first beam.

Aspect 16: The method of aspect 15, further comprising: performing a first quantity of channel contentions on a first uplink channel of the cell corresponding to the first beam; and receiving an adjusted first beam-specific periodicity for transmission of the first SSB based at least in part on the first quantity of channel contentions.

Aspect 17: The method of aspect 16, wherein the adjusted first beam-specific periodicity is based at least in part on the first quantity of channel contentions satisfying a threshold number of channel contentions for the first beam.

Aspect 18: The method of aspect 17, further comprising: receiving a decreased first beam-specific periodicity based at least in part on the first quantity of channel contentions being greater than the threshold number of channel contentions for the first beam.

Aspect 19: The method of any of aspects 17 through 18, further comprising: receiving an increased first beam-specific periodicity based at least in part on the first quantity of channel contentions being less than the threshold number of channel contentions for the first beam.

Aspect 20: The method of any of aspects 16 through 19, wherein the adjusted first beam-specific periodicity is based at least in part on user density distribution information associated with a spatial distribution of the UE and one or more UE for one or more time periods.

Aspect 21: The method of any of aspects 16 through 20, wherein the adjusted first beam-specific periodicity is based at least in part on a change in the first quantity of channel contentions during a first time period.

Aspect 22: The method of any of aspects 15 through 21, further comprising: receiving, via the first broadcast channel, a first message comprising a first indication of the first beam-specific periodicity for transmission of the first SSB using the first beam, and first position information of the first SSB in a corresponding synchronization signal burst.

Aspect 23: The method of aspect 22, wherein the first position information comprises a first bitmap indicating locations of the first SSB in the corresponding synchronization signal burst.

Aspect 24: The method of any of aspects 22 through 23, wherein the first indication comprises one or more fields in the first message corresponding to the first beam.

Aspect 25: The method of any of aspects 22 through 24, further comprising: receiving the first message comprising the first beam-specific periodicity indicated from a set of periodicities for transmission of the first SSB.

Aspect 26: The method of any of aspects 15 through 25, wherein the first broadcast channel comprises a first MIB that indicates the first beam-specific periodicity for transmission of the first SSB associated with the first beam.

Aspect 27: The method of any of aspects 15 through 26, further comprising: receiving, using a second beam associated with the network entity, a second SSB associated with the cell that corresponds to the UE, the second SSB comprising a second broadcast channel that indicates a second beam-specific periodicity for reception of the second SSB associated with the cell using the second beam, the second beam-specific periodicity being different from the first beam-specific periodicity.

Aspect 28: An apparatus for wireless communication at a network entity, comprising a processor; memory coupled with the processor; and instructions stored in the memory and executable by the processor to cause the apparatus to perform a method of any of aspects 1 through 14.

Aspect 29: An apparatus for wireless communication at a network entity, comprising at least one means for performing a method of any of aspects 1 through 14.

Aspect 30: A non-transitory computer-readable medium storing code for wireless communication at a network entity, the code comprising instructions executable by a processor to perform a method of any of aspects 1 through 14.

Aspect 31: An apparatus for wireless communication at a UE, comprising a processor; memory coupled with the processor; and instructions stored in the memory and executable by the processor to cause the apparatus to perform a method of any of aspects 15 through 27.

Aspect 32: An apparatus for wireless communication at a UE, comprising at least one means for performing a method of any of aspects 15 through 27.

Aspect 33: A non-transitory computer-readable medium storing code for wireless communication at a UE, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a network entity, comprising:
transmitting, using a first beam associated with the network entity, a first synchronization signal block associated with a cell supported by the network entity, the first synchronization signal block comprising a first broadcast channel that indicates a first periodicity for transmission of the first synchronization signal block associated with the cell using the first beam; and
transmitting, using a second beam associated with the network entity, a second synchronization signal block associated with the cell supported by the network entity, the second synchronization signal block comprising a second broadcast channel that indicates a second periodicity for transmission of the second synchronization signal block associated with the cell using the second beam, the second periodicity being different from the first periodicity.

2. The method of claim 1, further comprising:
monitoring for a first quantity of channel contentions on a first uplink channel of the cell corresponding to the first beam and a second quantity of channel contentions on a second uplink channel of the cell corresponding to the second beam, the first quantity of channel contentions and the second quantity of channel contentions associated with one or more user equipment (UE) attempting to access the first uplink channel and the second uplink channel;
adjusting the first periodicity for transmission of the first synchronization signal block based at least in part on the first quantity of channel contentions;
adjusting the second periodicity for transmission of the second synchronization signal block based at least in part on the second quantity of channel contentions; and
transmitting the first synchronization signal block and the second synchronization signal block in accordance with the first adjusted periodicity and the second adjusted periodicity.

3. The method of claim 2, further comprising:
adjusting the first periodicity, the second periodicity, or both, based at least in part on the first quantity of channel contentions satisfying a threshold number of channel contentions for the first beam, the second quantity of channel contentions satisfying the threshold number of channel contentions for the second beam, or both; and
transmitting the first synchronization signal block and the second synchronization signal block in accordance with the first adjusted periodicity and the second adjusted periodicity.

4. The method of claim 3, wherein adjusting the first periodicity, the second periodicity, or both, further comprises:
decreasing the first periodicity, the second periodicity, or both, based at least in part on the first quantity of channel contentions being greater than the threshold number of channel contentions for the first beam, the second quantity of channel contentions being greater than the threshold number of channel contentions for the second beam, or both; and
transmitting the first synchronization signal block and the second synchronization signal block in accordance with the first decreased periodicity and the second decreased periodicity.

5. The method of claim 3, wherein adjusting the first periodicity, the second periodicity, or both, further comprises:
increasing the first periodicity, the second periodicity, or both, based at least in part on the first quantity of channel contentions being less than the threshold number of channel contentions for the first beam, the second quantity of channel contentions being less than the threshold number of channel contentions for the second beam, or both; and
transmitting the first synchronization signal block and the second synchronization signal block in accordance with the first increased periodicity and the second increased periodicity.

6. The method of claim 2, further comprising:
obtaining user density distribution information associated with a spatial distribution of the one or more UE for one or more time periods;
adjusting the first periodicity, the second periodicity, or both, in accordance with the user density distribution information; and
transmitting the first synchronization signal block and the second synchronization signal block in accordance with the first adjusted periodicity and the second adjusted periodicity.

7. The method of claim 6, further comprising:
obtaining the user density distribution information based at least in part on a set of statistical user trends observed by the network entity for at least the one or more time periods.

8. The method of claim 2, wherein the first quantity of channel contentions, the second quantity of channel contentions, or both, change from a first time period to a second time period, the method further comprising:
adjusting the first periodicity, the second periodicity, or both, during the second time period based at least in part on the change in the first quantity of channel contentions, the change in the second quantity of channel contentions, or both; and
transmitting the first synchronization signal block and the second synchronization signal block in accordance with the first adjusted periodicity and the second adjusted periodicity.

9. The method of claim 1, further comprising:
transmitting, via the first broadcast channel, a first message comprising a first indication of the first periodicity for transmission of the first synchronization signal block using the first beam, and first position information of the first synchronization signal block in a corresponding synchronization signal burst; and
transmitting, via the second broadcast channel, a second message comprising a second indication of the second periodicity for transmission of the second synchronization signal block using the second beam, and second position information of the second synchronization signal block in the corresponding synchronization signal burst.

10. The method of claim 9, wherein the first position information comprises a first bitmap indicating locations of the first synchronization signal block in the corresponding synchronization signal burst, and the second position information comprises a second bitmap indicating locations of the second synchronization signal block in the corresponding synchronization signal burst.

11. The method of claim 9, wherein the first indication comprises one or more fields in the first message corresponding to the first beam and the second indication comprises one or more fields in the second message corresponding to the second beam.

12. The method of claim 9, further comprising:
selecting the first periodicity and the second periodicity from a set of periodicities for transmission of the first synchronization signal block and the second synchronization signal block; and
transmitting the first message comprising the selected first periodicity and the second message comprising the selected second periodicity.

13. The method of claim 1, wherein the first broadcast channel comprises a first master information block that indicates the first periodicity for transmission of the first synchronization signal block associated with the first beam, and the second broadcast channel comprises a second master information block that indicates the second periodicity for transmission of the second synchronization signal block associated with the second beam.

14. The method of claim 1, further comprising:
transmitting, using a third beam associated with the network entity, a third synchronization signal block associated with the cell supported by the network entity, the third synchronization signal block comprising a third broadcast channel that indicates a third periodicity for transmission of the third synchronization signal block associated with the cell using the third beam, the third periodicity being different from the first periodicity and the second periodicity.

15. A method for wireless communication at a user equipment (UE), comprising:
receiving a first synchronization signal and a second synchronization signal comprising time and frequency synchronization information for communications on a cell supported by a network entity; and
receiving a first synchronization signal block associated with the cell, the first synchronization signal block comprising a first broadcast channel that indicates a first beam-specific periodicity associated with transmission of the first synchronization signal block via a first beam.

16. The method of claim 15, further comprising:
performing a first quantity of channel contentions on a first uplink channel of the cell corresponding to the first beam; and
receiving an adjusted first beam-specific periodicity for transmission of the first synchronization signal block based at least in part on the first quantity of channel contentions.

17. The method of claim 16, wherein the adjusted first beam-specific periodicity is based at least in part on the first quantity of channel contentions satisfying a threshold number of channel contentions for the first beam.

18. The method of claim 17, further comprising:
receiving a decreased first beam-specific periodicity based at least in part on the first quantity of channel contentions being greater than the threshold number of channel contentions for the first beam.

19. The method of claim 17, further comprising:
receiving an increased first beam-specific periodicity based at least in part on the first quantity of channel contentions being less than the threshold number of channel contentions for the first beam.

20. The method of claim 16, wherein the adjusted first beam-specific periodicity is based at least in part on user density distribution information associated with a spatial distribution of the UE and one or more UE for one or more time periods.

21. The method of claim 16, wherein the adjusted first beam-specific periodicity is based at least in part on a change in the first quantity of channel contentions during a first time period.

22. The method of claim 15, further comprising:
receiving, via the first broadcast channel, a first message comprising a first indication of the first beam-specific periodicity for transmission of the first synchronization signal block using the first beam, and first position information of the first synchronization signal block in a corresponding synchronization signal burst.

23. The method of claim 22, wherein the first position information comprises a first bitmap indicating locations of the first synchronization signal block in the corresponding synchronization signal burst.

24. The method of claim 22, wherein the first indication comprises one or more fields in the first message corresponding to the first beam.

25. The method of claim 22, further comprising:
receiving the first message comprising the first beam-specific periodicity indicated from a set of periodicities for transmission of the first synchronization signal block.

26. The method of claim 15, wherein the first broadcast channel comprises a first master information block that indicates the first beam-specific periodicity for transmission of the first synchronization signal block associated with the first beam.

27. The method of claim 15, further comprising:
receiving, using a second beam associated with the network entity, a second synchronization signal block associated with the cell that corresponds to the UE, the second synchronization signal block comprising a second broadcast channel that indicates a second beam-specific periodicity for reception of the second synchronization signal block associated with the cell using the second beam, the second beam-specific periodicity being different from the first beam-specific periodicity.

28. An apparatus for wireless communication at a network entity, comprising:
a processor;
memory coupled with the processor; and
instructions stored in the memory and executable by the processor to cause the apparatus to:
transmit, using a first beam associated with the network entity, a first synchronization signal block associated with a cell supported by the network entity, the first synchronization signal block comprising a first broadcast channel that indicates a first periodicity for transmission of the first synchronization signal block associated with the cell using the first beam; and
transmit, using a second beam associated with the network entity, a second synchronization signal block associated with the cell supported by the network entity, the second synchronization signal block comprising a second broadcast channel that indicates a second periodicity for transmission of the second synchronization signal block associated with the cell using the second beam, the second periodicity being different from the first periodicity.

29. The apparatus of claim 28, wherein the instructions are further executable by the processor to cause the apparatus to:
monitor for a first quantity of channel contentions on a first uplink channel of the cell corresponding to the first beam and a second quantity of channel contentions on a second uplink channel of the cell corresponding to the second beam, the first quantity of channel contentions and the second quantity of channel contentions associated with one or more user equipment (UE) attempting to access the first uplink channel and the second uplink channel;
adjust the first periodicity for transmission of the first synchronization signal block based at least in part on the first quantity of channel contentions;
adjust the second periodicity for transmission of the second synchronization signal block based at least in part on the second quantity of channel contentions; and
transmit the first synchronization signal block and the second synchronization signal block in accordance with the first adjusted periodicity and the second adjusted periodicity.

30. An apparatus for wireless communication at a user equipment (UE), comprising:
a processor;
memory coupled with the processor; and
instructions stored in the memory and executable by the processor to cause the apparatus to:
receive a first synchronization signal and a second synchronization signal comprising time and frequency synchronization information for communications on a cell supported by a network entity; and
receive a first synchronization signal block associated with the cell, the first synchronization signal block comprising a first broadcast channel that indicates a first beam-specific periodicity associated with transmission of the first synchronization signal block via a first beam.
